(19) United States
(12) Patent Application Publication
(10) Pub. No.: US 2026/0367219 A1
(43) Pub. Date: Nov. 19, 2026

(54) METHODS, ARCHITECTURES, APPARATUSES, AND SYSTEMS FOR ADAPTIVE REFERENCE SIGNAL TRANSMISSION FOR SENSING

(71) Applicant: InterDigital Patent Holdings, Inc., Wilmington, DE (US)

(72) Inventors: Mohammad Heggo, London (GB); Arman Shojaeifard, London (GB); Yasser Mestrah, London (GB); Ibrahim Hemadeh, Hemel Hempstead (GB); Deepa Gurmukhdas Jagyasi, London (GB); Alain Mourad, Ascot (GB)

(21) Appl. No.: 19/208,434

(22) Filed: May 14, 2025

(51) Int. Cl. G01S 7/03

(52) U.S. Cl. CPC G01S 7/03

(57) ABSTRACT

A sensing task is performed by a network relative to a target with the assistance of a wireless transmit and/or receive unit (WTRU). A difference between expected and measured parameters triggers a change to improve the sensing task. A method performed by the WTRU includes at least one of receiving configuration information indicating a first measurement time window and an expected parameter; receiving one or more reference signals (RSS) reflected from the target within the first measurement time window; determining a measured parameter of the target based on the one or more RSs; determining a difference between the expected parameter and the measured parameter of the target based on the one or more RSs; determining a recommended configuration for the one or more RSs or a second measurement time window; or transmitting, to the wireless network, information related to the same.

### TECHNICAL FIELD

The present disclosure is generally directed to the fields of communications, software and coding, including, for example, to methods, architectures, apparatuses, systems related to communications and sensing.

### BACKGROUND

A Logical Channel Prioritization (LCP) procedure involves scheduling of uplink data by Radio Resource Control (RRC) signaling, which sets priorities, prioritized bit rates, and bucket size durations for each logical channel. The RRC signaling also configures mapping restrictions such as allowed subcarrier spacing, maximum Physical Uplink Shared Channel (PUSCH) duration, and/or allowed serving cells. A Medium Access Control (MAC) entity maintains a variable for each logical channel, incrementing it based on the prioritized bit rate and time elapsed. During new transmissions, the MAC entity selects one or more logical channels that meet specific conditions and allocates resources in decreasing priority order. If resources remain, they are allocated to logical channels in strict priority order. The MAC entity follows specific rules for segmenting Radio Link Control (RLC) Service Data Units (SDUs) and maximizing data transmission and may skip uplink transmission under certain conditions. However, as regards a sensing task, technical challenges in implementation and effectiveness remain.

### SUMMARY

In certain representative embodiments, a method may include receiving, from a wireless network, configuration information indicating a first measurement time window and an expected parameter. The method may also include receiving one or more reference signals (RSs) reflected from a target within the first measurement time window. The method may furthermore include determining a measured parameter of the target based on the one or more RSs reflected from the target. The method may in addition include determining a difference between the expected parameter and the measured parameter of the target based on the one or more RSs reflected from the target. The method may moreover include determining, for at least one future transmission and based on the difference between the expected parameter and the measured parameter of the target, at least one of (1) a recommended configuration for the one or more RSs or (2) a second measurement time window. The method may also include transmitting, to the wireless network, at least one of (1) an indication of the difference between the expected parameter obtained from the one or more RSs and the measured parameter obtained from the one or more RSs reflected from the target, (2) information about the measured parameter of the target based on the one or more RSs reflected from the target, (3) information about the recommended configuration for the one or more RSs for the at least one future transmission, or (4) information about the second measurement time window for the at least one future transmission.

Implementations may include one or more of the following features. The method where: the expected parameter obtained from the one or more RSs reflected from the target is an expected micro-Doppler (MD) profile, and the measured parameter of the target based on the one or more RSs reflected from the target is a measured MD profile. The method where the determining the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target satisfies a configured number of harmonics. The method where the determining the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target reflected from the target within the first measurement time window satisfies a configured threshold. The method where the determining the difference between the expected MD profile obtained from the one or more RSs reflected from the target, and the measured MD profile of the target based on the one or more RSs reflected from the target within the first measurement time window is further based on determining that a difference in a measured metric of the one or more RSs of a configured number of consecutive RSs within the first measurement time window satisfies a configured threshold. The method where the determining the difference between the expected MD profile obtained from the one or more RSs reflected from the target, and the measured MD profile of the target based on the one or more RSs reflected from the target within the first measurement time window is further based on determining a difference in a rate of change in a measured metric of the one or more RSs of a configured number of consecutive RSs within the first measurement time window satisfies a configured threshold. The method where the determining the difference between the expected MD profile obtained from the one or more RSs reflected from the target, and the measured MD profile of the target based on the one or more RSs reflected from the target within the first measurement time window is further based on expected maximum target MD frequency and measured maximum target MD frequency. The method where the determining the difference between the expected MD profile obtained from the one or more RSs reflected from the target, and the measured MD profile of the target based on the one or more RSs reflected from the target within the first measurement time window is further based on expected maximum MD profile energy and measured maximum MD profile energy. The method where the determining the difference between the expected MD profile obtained from the one or more RSs reflected from the target, and the measured MD profile of the target based on the one or more RSs reflected from the target within the first measurement time window is further based on expected time profile energy and measured time profile energy. The method where: the expected parameter obtained from the one or more RSs reflected from the target is at least one of a transmission rate of the one or more RSs configured by the wireless network, an expected MD profile, an expected radar cross section (RCS), an expected power profile, or an expected angle profile, and the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile.

In certain representative embodiments, a WTRU may include a processor, and a transceiver coupled to the processor, where the WTRU is configured to: receive, from a wireless network, configuration information indicating a first measurement time window and an expected parameter; receive one or more reference signals (RSs) reflected from a target within the first measurement time window; determine a measured parameter of the target based on the one or more RSs reflected from the target; determine a difference between the expected parameter and the measured parameter of the target based on the one or more RSs reflected from the target; determine, for at least one future transmission and based on the difference between the expected parameter and the measured parameter of the target, at least one of (1) a recommended configuration for the one or more RSs or (2) a second measurement time window; and transmit, to the wireless network, at least one of (1) an indication of the difference between the expected parameter obtained from the one or more RSs and the measured parameter obtained from the one or more RSs reflected from the target, (2) information about the measured parameter of the target, (3) information about the recommended configuration for the one or more RSs for the at least one future transmission, or (4) information about the second measurement time window for the at least one future transmission.

Implementations may include one or more of the following features. The WTRU where: the expected parameter obtained from the one or more RSs reflected from the target is an expected micro-Doppler (MD) profile, and the measured parameter of the target based on the one or more RSs reflected from the target is a measured MD profile. The WTRU where the WTRU configured to determine the difference between the expected MD profile obtained from the one or more RSs reflected from the target, and the measured MD profile of the target based on the one or more RSs reflected from the target within the first measurement time window further determines that a number of measured harmonics of the measured MD profile of the target satisfies a configured number of harmonics. The WTRU may be configured to determine the difference between the expected MD profile obtained from the one or more RSs reflected from the target, and the measured MD profile of the target based on the one or more RSs reflected from the target within the first measurement time window is further configured to determine that a number of measured harmonics of the measured MD profile of the target reflected from the target within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is further configured to determine that a difference in a measured metric of the one or more RSs of a configured number of consecutive RSs within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is further configured to determine a difference in a rate of change in a measured metric of the one or more RSs of a configured number of consecutive RSs within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is based on expected maximum target MD frequency and measured maximum target MD frequency. The WTRU may be configured to determine the difference between the expected MD profile obtained from the one or more RSs reflected from the target, and the measured MD profile of the target based on the one or more RSs reflected from the target within the first measurement time window is based on expected maximum MD profile energy and measured maximum MD profile energy. The WTRU may be configured to determine the difference between the expected MD profile obtained from the one or more RSs reflected from the target, and the measured MD profile of the target based on the one or more RSs reflected from the target within the first measurement time window is based on expected time profile energy and measured time profile energy. The expected parameter obtained from the one or more RSs reflected from the target is at least one of a transmission rate of the one or more RSs configured by the wireless network, an expected MD profile, an expected radar cross section (RCS), an expected power profile, or an expected angle profile, and the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an example diagram of a system including a gNB, a target (e.g., an unmanned aerial vehicle (UAV), a drone, or the like), and a WTRU, in accordance with one or more embodiments of the present disclosure;

FIG. 3 is an example chart of a power-delay profile of a received RS, in accordance with one or more embodiments of the present disclosure;

FIG. 4 is an example chart of a power-delay profile of accumulated received RS resources, in accordance with one or more embodiments of the present disclosure;

FIG. 5A is an example chart of a configured MD profile of a target, in accordance with one or more embodiments of the present disclosure;

FIG. 5B is an example chart a measured MD profile of the target, in accordance with one or more embodiments of the present disclosure;

FIG. 6A is an example chart of a configured RS received power (RSRP) time profile of a target, in accordance with one or more embodiments of the present disclosure;

FIG. 6B is an example chart a measured RS received power (RSRP) time profile of the target, in accordance with one or more embodiments of the present disclosure;

FIG. 7A is an example chart of a configured RSRP-time profile, in accordance with one or more embodiments of the present disclosure;

FIG. 7B is an example chart a measured RSRP-time profile, in accordance with one or more embodiments of the present disclosure; and

FIG. 8 is an example process for adaptive RS transmission for target sensing, in accordance with one or more embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

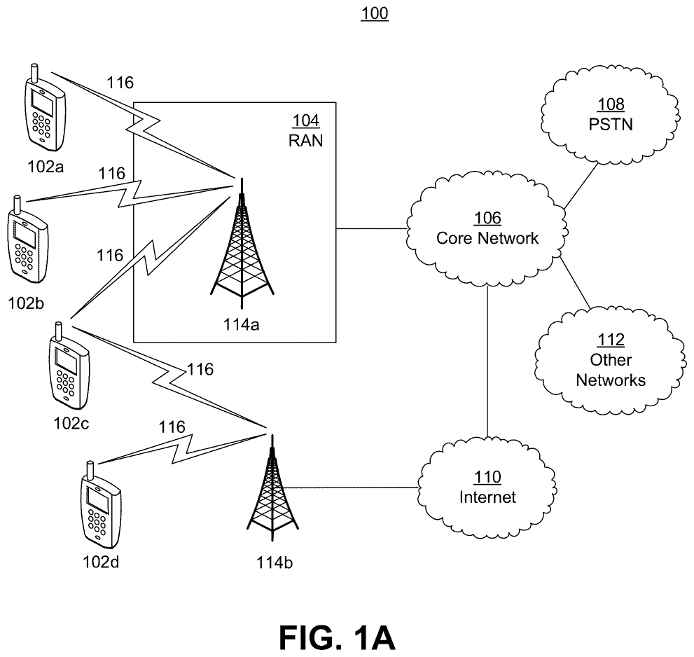

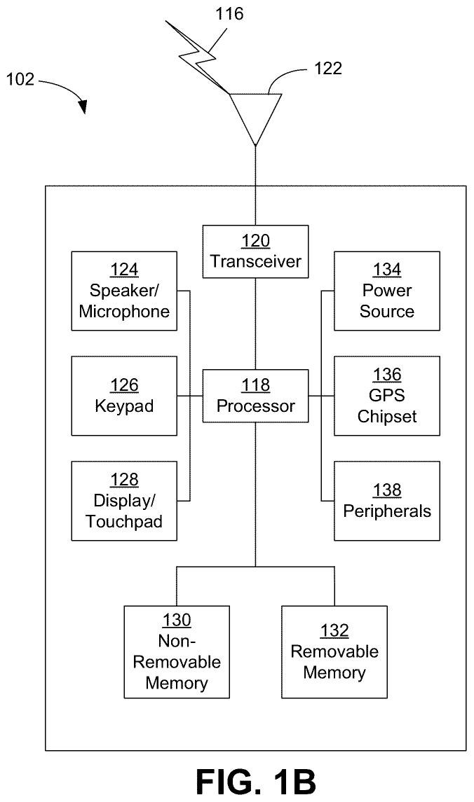

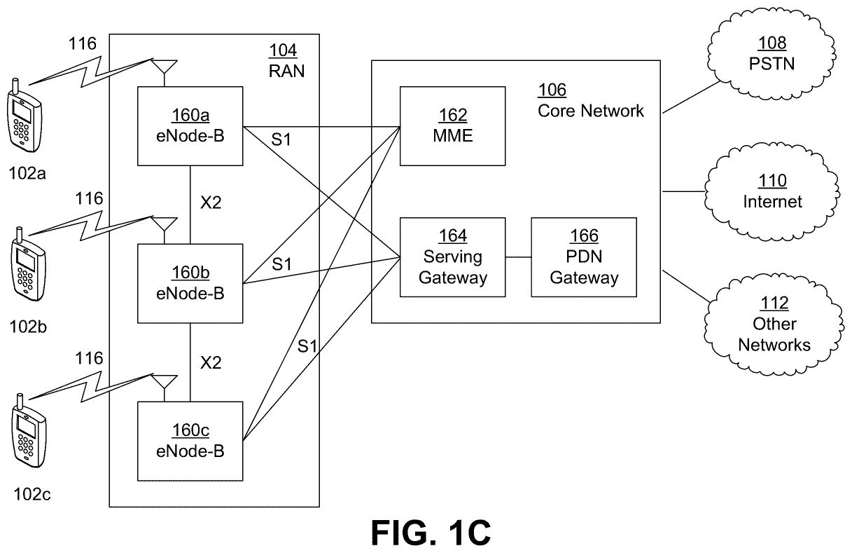

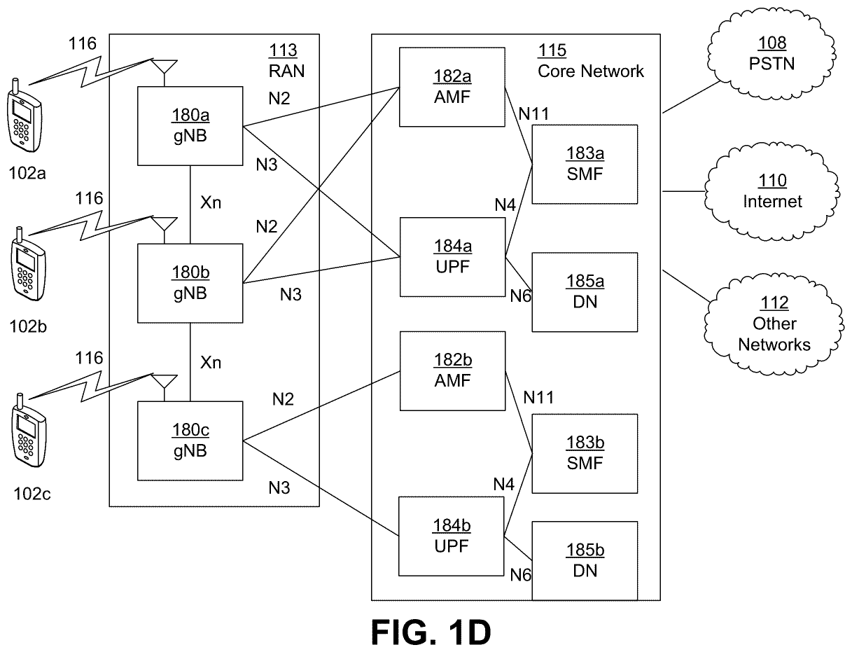

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

It will be understood that a wireless network may include any suitable components and devices, including, for example, any of one or more base stations, one or more transmission reception points (TRPs), one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

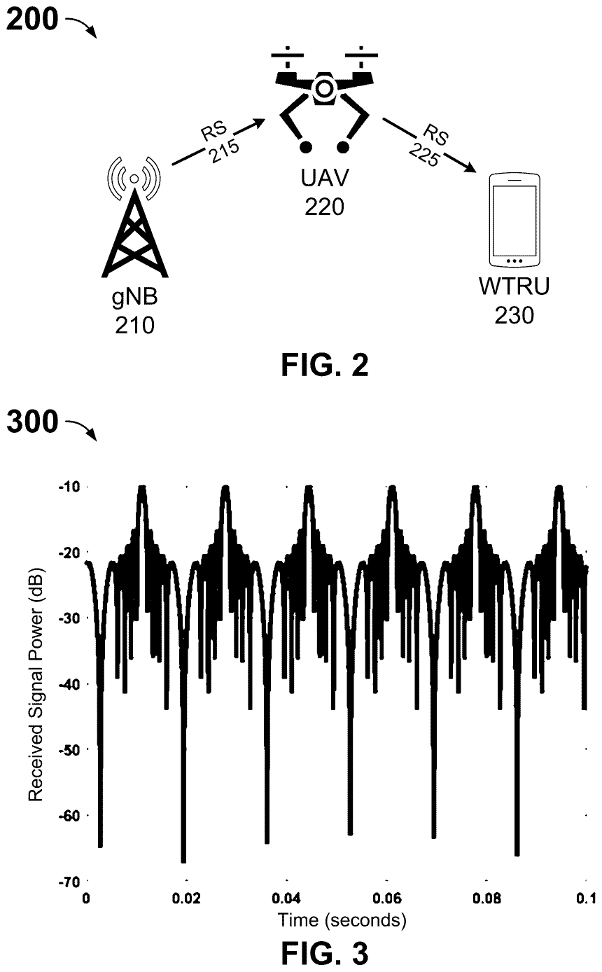

In certain representative embodiments, the devices, systems, architectures, communication links, apparatuses, and other elements depicted in FIGS. 1A-1D may be used in connection with at least one of communications, measurement, sensing, or reporting of the same including embodiments described below at least in connection with FIGS. 2-8.

In certain representative embodiments, a WTRU (e.g., 102, 230, or the like) is configured for adaptive RS transmission for target sensing. For example, the WTRU is configured for ISAC. Also, for example, the WTRU is configured to determine a mismatch between an expected and/or configured and/or transmitted rate of an RS transmission and a measured and/or received rate of the RS transmission. As used herein, where the term “mismatch” is used, the mismatch may correspond, for example, to a difference between an expected parameter and a measured parameter. As pertains to RS transmissions, the difference between the expected parameter and the measured parameter of an RS may be referred to as an “RS transmission rate mismatch.” As used herein, where the term “RS” is provided in the singular, it is understood that one or more RSs may be provided. Further, for example, a recommended time profile is provided for an RS configuration (e.g., RS periodicity time profile, RS transmission power time profile, etc.).

In certain representative embodiments, a WTRU determines an RS transmission rate mismatch, e.g., within a measurement time window or a local interval, e.g., within the measurement time window, e.g., based on comparing measured and configured target profiles (e.g., frequency profile, time profile, etc.).

In certain representative embodiments, a WTRU reports at least one of a determined RS transmission rate mismatch, a determined time interval within a measurement time window of the mismatch, an RS transmission rate level (e.g., high, low, etc.), or a preferred RS configuration time profile.

Micro-Doppler (MD) refers to frequency or phase alterations in signals reflected from a target, caused by subtle movements such as rotation, vibration, or hand gestures. This effect results in sideband shifts around a primary Doppler frequency shift due to a target's bulk motion and varies over time. Examples of factors influencing the MD effect include at least one of motion amplitude, frequency, periodicity, carrier frequency, direction, or the like.

MD signatures can be used to distinguish between a sensing target and an unintended target, e.g., distinguishing an unmanned aerial vehicle (UAV) from a bird, or the like. 3GPP ISAC channel models include a unified model to model both macro-Doppler and MD motion of a target as in the following Equation (1):

V̅_{SP}=V̅_{macro}+v̅_{micro} (1)

where v̅ₛₚ is a combined velocity of a scattering point of the target, and v̅_{macro} and v̅_{micro} represent a velocity of the target macro-motion and micro-motion, respectively.

The MD signature of a sensing target can be measured by transmitting a series of reference signal (RS) resources and measuring the accumulated time and/or frequency profile of the received RS metrics after bouncing from the target (e.g., RS received power (RSRP), RS received power per path (RSRPP), RS carrier phase (RSCP), etc.).

For example, as shown in FIG. 2, a system 200 includes at least one of a gNB 210, a target (e.g., an unmanned aerial vehicle (UAV) 220 or drone, or the like), a WTRU 230, or the like. For example, a sensing target is the UAV 220. An RS 215 is transmitted from the gNB 210 towards the UAV 220. The RS 215 is reflected by the UAV 220, which results in RS 225, which may be measured and/or detected by the WTRU 230. In this example, a number of propellers of the UAV 220 is 1, a rotation frequency is 30 Hz, a carrier frequency is 15 GHz, and a propeller length 52, where A represents carrier wavelength. The propeller is assumed to be rotating around an origin point at a mid-point of the propeller, which will result in an equivalent rotation frequency of 60 Hz. As used herein, where “reflect” (or the like) is used, it is to be understood that, for example, the wireless network (e.g., gNB) transmits an RS, which reflects off a target (e.g., a drone). Also, for example, one or more reflected signals are used in sensing tasks to detect at least one of a presence, a position, a characteristic, or the like, of one or more objects. Further, for example, 3GPP sensing data is generally understood to refer to data derived from 3GPP radio signals impacted (e.g., reflected, deflected, refracted, diffracted, or the like) by an object or environment.

For example, FIG. 3 is a chart 300 showing an example of a power-delay profile of a reflected RS from a UAV. The chart 300 indicates received signal power in decibels (dB) (y-axis) versus time in seconds (x-axis). The chart 300 shows a periodic change in a received reflected signal power from a target (e.g., a UAV) due to a rotation motion of a propellor of the UAV. A length of each of these periodic changes is about 0.0166 s, which corresponds to the rotation frequency of 60 Hz. The chart 300 shows around 6 instances or time periods of the UAV propeller rotation motions within a time of about 0.1 s. It is observed that within each period of 0.0166 s, a change in the received reflected signal power from the target can include multiple frequency components and may require a specific RS configuration.

In certain representative embodiments, in order to detect an MD signature of a sensing target, an ISAC transmitter is configured to send multiple (e.g., in time, frequency, space, or the like) RS resources towards the sensing target. The multiple RS resources are reflected from the sensing target and received at the ISAC receiver. The receiver then aggregates (within a measurement window) all the measured reflected RS resources (e.g., RSRPP, RSCP, signal to interference noise ratio (SINR), etc.) to obtain an RS metric needed to sense the target, e.g., time and frequency profiles, or the like.

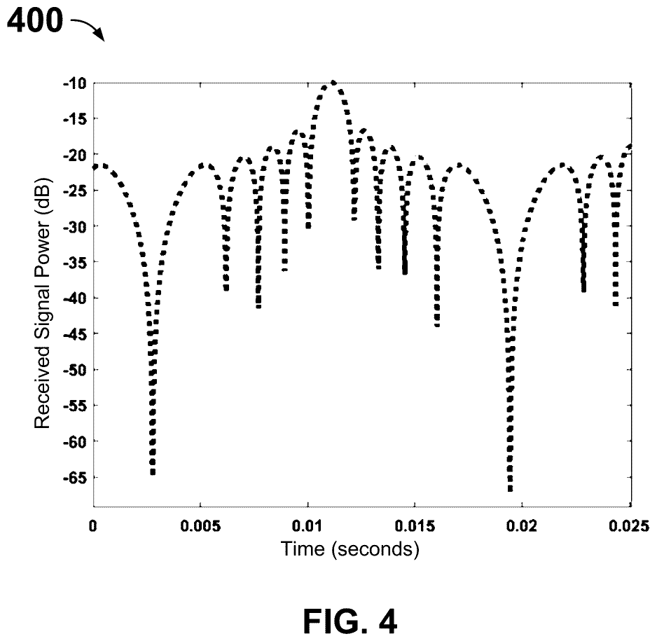

For example, FIG. 4 is a chart 400 showing an example of a power-delay profile of a reflected RS signal from a UAV target during 0.0166 s of a periodic length of a UAV propeller rotation motion. The chart 400 indicates received signal power in dB (y-axis) versus time in seconds (x-axis). Each dot in FIG. 4 represents a measured power or phase of the received RS from the UAV target. An RS transmission periodicity and a repetition factor of the RS resource may influence a time between two consecutive dots in FIG. 4 (i.e., the sampling time of the MD motion in the time domain).

In certain representative embodiments, e.g., in an ISAC scenario, a transmitter may send a sequence of RS resources towards a target for a given sensing task (e.g., MD signature measurement). Each RS reflected from the target may represent a sample in an RS metric profile of the target (e.g., RSRP time profile, RSCP time profile, etc.). The receiver may receive the reflected RS from the target and measure a corresponding RS metric profile (e.g., RSRP, RSCP, SINR, etc.) over a measurement time window. A WTRU may determine a selected number of one or more received RSs to be included in the RS profile of the target (e.g., based on the RSRPP of the corresponding RS being above a configured threshold, or the like) for a given sensing task. The selected one or more RSs may influence an accuracy, and an efficiency of the resources used to obtain the RS profile of the target. In one example, when a transmission periodicity of the one or more selected RSs is less than twice a maximum MD frequency of a target sub-motion (e.g., rotation and/or vibration frequency, or the like), accuracy may be reduced for a measured target profile and a corresponding uncertainty range may be increased. In another example, when a number of the one or more selected RSs is more than twice the maximum MD frequency of the target sub-motion, associated signaling overhead leads to inefficient use of allocated power and memory resources of the WTRU.

For example, an RS configuration (periodicity, muting pattern, etc.) of a sequence of one or more RSs over a measurement time window may impact accuracy of a measured target RS profile (e.g., Nyquist sampling). However, if the RS profile of the target is composed of multiple frequencies or has non-uniform behavior over the measurement time window, the use of a single periodicity value (e.g., regular sampling) may be associated with some challenges.

For example, if a periodicity is associated with a highest frequency component of an RS profile, this may lead to oversampling of the RS profile at time intervals where the highest frequency component does not exist. This leads to an RS high transmission rate problem (e.g., transmission of unnecessary RS resources), more signaling overhead, and the use of (e.g., otherwise unnecessary) storage and power resources at the WTRU side.

In another example, if the periodicity is associated with a lowest frequency component of the RS profile, this may lead to low measured accuracy of relatively high frequency components of the RS profile.

Also, for example, other factors that may impact the received RS from the target may include at least one of: a status of target sensing link (e.g., Transmitter (Tx)-Target-Receiver (Rx), or the like), whether the received RS is line-of-sight (LoS) and/or non-LOS (NLoS), a number of environmental objects (EO) that are within a vicinity of the target, or the like. These factors may degrade the quality of the reflected RS from the target and may impact the number of eligible RS samples (e.g., above RSRPP threshold) in the target profile.

As noted briefly hereinabove, in existing 3GPP specifications, there is no support for measuring an RS metric (e.g., RSRPP, RSCP, SINR, or the like), a time profile, or a frequency profile that is reflected from a sensing target. The current 3GPP specifications (e.g., Release 18) define a configuration of reference signals (e.g., positioning reference signal (PRS)) that may include at least one of periodicity, repetition factor, transmission power, or the like. However, in an ISAC scenario, measurement of RS metric time or frequency profile over a measurement time window may require an adaptive RS configuration based on the measured RS profile of the target for the given sensing task. Various embodiments, implementations, and examples of an adaptive RS configuration are provided in detail herein.

For example, methods, systems, and devices are provided for configuring a WTRU to determine and report to a network an RS transmission rate within a measurement time window for a given sensing task (e.g., a MD motion profile measurement), which may be based on a measured RS profile (e.g., time profile, frequency profile, etc.) of a target and configured thresholds.

Examples of terminology are provided hereinbelow. As used herein, a network (NW) may include at least one of an access and mobility management function (AMF), a location management function (LMF), a Sensing Function (SF), gNB, NG-RAN, or the like. An LMF is a non-limiting example of a node or entity (e.g., network node or entity, or the like) that may be used for or to support positioning and/or sensing. Any other node or entity, such as SF, may be substituted for LMF and still be consistent with one or more embodiments presented herein. A WTRU may receive one or more preconfigured thresholds from the network (e.g., LMF, gNB, or the like). As used herein, pre-configuration and configuration may be used interchangeably. A WTRU location may be expressed in terms of altitude, latitude, geographic coordinate, or local coordinate, for example.

As used herein, a timestamp be indicated by absolute time, relative time (e.g., in seconds) compared to a reference time, system frame number (SFN), slot index, frame index, subframe index, and/or symbol index. Examples of “absolute time” may be coordinated universal time (UTC) time, global navigation satellite system (GNSS) time, locally defined absolute time (e.g., LTE or NR Time), or the like.

In the examples described herein, the WTRU may receive one or more configurations for a time window such as duration (e.g., expressed in terms of seconds, number of symbols, number of slots, number of frames, number of subframes, or the like), start and/or end time (e.g., expressed in terms of absolute time, system time, relative time with respect to a reference time indicated by the network or determined by the WTRU, SNF index, slot index, symbol index, frame index, subframe index, or the like).

The WTRU may receive more than one configuration of a time window where each configuration is associated with an index. The time window can be initiated with a trigger sent by the network. For example, the WTRU may receive a command (e.g., downlink control information (DCI)) to initiate an indicated time window, indicated via the configuration index. The WTRU may determine to initiate the time window after a configured duration after reception of the command (e.g., N symbols, N slots, N frames, N seconds, or the like). The WTRU may receive an activation or deactivation command (e.g., DCI, MAC control element (MAC-CE), or the like) to activate or deactivate the time window, respectively, from the network.

Examples of general WTRU behavior are provided. The WTRU may send a request to the NW for configuration including downlink (DL) RS and uplink (UL) RS configurations, such as measurement information, processing window, transmission window, etc. The request may be carried through radio resource control (RRC), MAC-CE, physical uplink shared channel (PUSCH), physical uplink control channel (PUCCH), uplink control information (UCI), Local Measurement Unit (LMU) Global System for Mobile Communications/Enhanced Data rates for GSM Evolution (GSM/EDGE) Location Services (LCS) Protocol (a.k.a., LLP) message, etc. The WTRU may send an acknowledgement of the grant message received through PUSCH or PUCCH.

The WTRU configuration may include one or more conditions associated with one or more WTRU behaviors. The WTRU may determine behavior of the WTRU based on a given set of conditions. The WTRU may be preconfigured with conditions and associated WTRU behaviors, for example, through RRC, LLP message, etc. The WTRU may, e.g., according to the pre-configuration, determine an action based on a given set of conditions.

The WTRU can measure the DL RS within or outside an active bandwidth part (BWP). The WTRU may transmit the UL RS within or outside the active BWP. The WTRU may include, in addition to measurements on the DL RS, cell-related measurements, such as those based on at least one of synchronization signal block (SSB), channel state information (CSI)-RS, demodulation RS (DMRS), or the like.

Definitions of an RS transmission mismatch rate, an RS profile, and a target profile, as used herein, are provided. Regarding the RS transmission mismatch rate, in one example, the WTRU may be configured to measure the target profile and/or the reflected RS profile from the target (e.g., RSRPP time and/or frequency profile, radar cross section (RCS) profile, etc.) within a measurement time window. In one solution, an RS transmission rate mismatch may refer to a case when a number of one or more measured RSs that are received at a WTRU is above or below a configured threshold within a configured measurement time window. As used herein, the phrase “above or below” is not limiting, i.e., it is understood that the term includes at least one of “at or above,” “greater than or equal to,” “above,” “greater than,” “at or below,” “less than or equal to,” “below,” “less than,” or the like. In another solution, the RS transmission rate mismatch may refer to the case when the number of the one or more measured RSs within a configured time interval in the measurement time window is above or below a configured threshold.

The RS profile may refer to the measured RS metric pattern (e.g., RSRPP, RSRP, RSCP, SINR, etc.) that is measured over different frequencies, time slots, angles, etc.

The target profile may refer to any information that describes characteristics of the target that may include at least one of geometrical characteristics (e.g., size, dimension, shape, etc.), physical characteristics (e.g., material), electromagnetic characteristics (e.g., reflectivity, radar cross section (RCS), etc.), location, mobility (e.g., velocity), or the like. The target profile may refer to a single value or multiple values that are evaluated across different time intervals, frequencies, angles, locations, etc. (e.g., probability distribution function). For example, the target RCS profile may refer to the target one or more RCS patterns that are evaluated at different frequencies, angles, time intervals, etc. In one example, the target RCS frequency profile may refer to the target RCS pattern that is evaluated at different frequencies. In another example, the target RCS angular profile may refer to the RCS pattern that is evaluated at different angles (e.g., angles of arrivals, angles of departure, incidence and/or scattering angle from the target, etc.).

In certain representative embodiments, a WTRU is configured with a set of RS resources to use for performing and/or reporting one or more sensing measurements. For example, the WTRU detects if a mismatch between the RS transmission rate (e.g., high or low, or the like) and the configured RS transmission rate is triggered, e.g., based on RS measurements over the configured measurement time window, and configured thresholds. Also, for example, the WTRU determines and/or reports the preferred RS configuration (e.g., recommended configuration within the measurement time window or within time intervals in the measurement time window or for future transmission time intervals such as RS periodicity time function, RS transmission power function, or the like). Further, for example, the WTRU sends a report to the network that contains at least one of the detected RS transmission rate mismatch, corresponding RS measurements, recommended RS configuration time profile, or the like.

For example, a WTRU performs one or more actions and/or steps. For example, the actions and/or steps include at least one of receiving a configuration related to one or more sensing tasks, receiving and/or measuring one or more RSs reflected from a (e.g., sensing) target, determining a recommended RS configuration for current and/or future transmission, reporting one or more types of information regarding the same, or the like.

For example, a WTRU, which is capable of reporting measurements requested by a network, receives a configuration from the network, e.g., via RRC signaling, MAC-CE, DCI, or the like. The configuration indicates a start of one or more sensing tasks (e.g., target MD frequency profile measurement) related to a sensing target. The one or more sensing tasks may include at least one of a sensing RS configuration, sensing RS measurement and/or reporting configurations, sensing assistance data, or the like.

For example, the sensing RS configuration may include a PRS configuration or the like.

For example, the sensing RS measurement and/or reporting configurations may include at least one of: one or more metrics to be measured, one or more default and/or first measurement configurations, one or more thresholds for detection of RS transmission rate mismatch, one or more resources for indicating and/or reporting MD sampling, one or more reporting formats, or the like.

For example, the one or more metrics may be measured as RSRP, RSRPP, RSCP, angle of arrival (AoA), MD, or the like. Further, for example, the metrics may be associated with the sensing target task, or the like.

For example, the one or more default and/or first measurement configurations include at least one of a default measurement window size, an expected and/or first MD frequency, a range of one or more MD frequencies, an initial list of one or more times and/or one or more angles for one or more measurements, an initial number of periodic measurements, or the like.

For example, the one or more thresholds for detection of RS transmission rate mismatch may include at least one of maximum MD frequency, a number of one or more RSs, or the like. Also, for example, the one or more thresholds include one or more maximum MD frequencies. In one solution, the one or more MD frequencies may refer to the N frequency harmonic of the measured target MD fundamental frequency. In another solution, the one or more MD frequencies may refer to the measured target fundamental frequency plus a threshold value. Further, for example, the number of the one or more RSs may be within a measurement time window or within a time period of the measurement time window.

For example, the one or more resources for indicating and/or reporting MD sampling may be explicit or implicit.

For example, the one or more reporting formats include at least one of one-bit signaling, an up command, a down command, a percentage, or the like.

For example, the sensing assistance data for the sensing target includes at least one of a sensing target identifier, sensing target profile information, sensing target positioning information, a NW indication of the sensing target link status (e.g., LoS or NLoS), or the like.

For example, the WTRU receives and/or measures the one or more RSs that are reflected from the target. Also, for example, the WTRU measures the target MD profile and determines the detection of the RS transmission rate mismatch within a measurement time window. Further, for example, the determination of the detection of the RS transmission rate mismatch within the measurement time window is based on at least one of: (1) a determination that a measured number of target MD harmonics is above or below a configured number of harmonics; (2) a number of the one or more measured RSs that are reflected from the target within the measurement time window (or time period of the measurement time window) being above or below a preconfigured threshold (e.g., as in the interpolation polynomial degree); (3) a difference in the measured RS metric of a configured number (N) of one or more consecutive RSs within the measurement time window or configured time period of the measurement time window being below a preconfigured threshold (as used herein, the term “configured consecutive N RS(s)” refers to a configured number (N) of one or more consecutive RSs); (4) a difference in a rate of change in the measured RS metric of the configured consecutive N RS(s) within the measurement time window or configured time period of the measurement time window being below a preconfigured threshold; (5) a target sensing link status (e.g., LoS or NLoS); (6) a number of environmental objects (EOs) is above or below a preconfigured threshold; (7) a minimum distance between an EO and the target is above or below a preconfigured threshold; or (8) the like.

For example, the WTRU determines the recommended RS configuration for current and/or future transmission based on a determined RS transmission rate mismatch. Also, for example, the determined RS transmission rate mismatch may include at least one of an RS transmit power time profile within the measurement time window, an RS periodicity time profile within the measurement time window, an RS muting pattern and/or repetition factor time profile within the measurement time window, or the like.

For example, the WTRU reports (e.g., to the network) at least one of: one or more RS profile measurements, an indication of the RS transmission rate mismatch, an RS transmission rate level (e.g., high, low, etc.), the recommended RS configuration (e.g., within a newly determined measurement time window), or the like.

For example, methods, systems, and devices are provided for WTRU measurement and/or reporting. Also, for example, the WTRU measurement and/or reporting may be related to adapting an RS transmission rate within a measurement time window. Further, for example, the adapting the RS transmission rate within the measurement time window may be based on a configured target profile (e.g., time profile, frequency profile, etc.). In addition, for example, the configured target profile may be associated with a target sensing task. Moreover, for example, the WTRU, configured in the manner described herein, reduces signaling overhead. Furthermore, for example, the WTRU, configured in the manner described herein, reduces signaling overhead that may otherwise by incurred by reporting and/or updating a report at incorrect time intervals. Additionally, for example, the WTRU, configured in the manner described herein, avoids reconfiguration otherwise required for increasing a received SNR. Still further, for example, the WTRU, configured in the manner described herein, avoids reconfiguration otherwise required for increasing a measured accuracy of sensing task output.

In certain representative embodiments, a WTRU, e.g., for adaptive RS transmission for target sensing, includes at least one of a configuration, WTRU measurement of an RS profile, WTRU reporting, a WTRU report update, additional WTRU behaviors, or the like.

For example, the configuration includes at least one of WTRU capability information, an RS configuration, one or more RS transmission rate mismatch detection triggering conditions, one or more measurement configurations for one or more RS profiles, one or more report configurations, sensing assistance data, or the like.

For example, regarding the WTRU capability information, the WTRU may receive and/or decode an initial request, e.g., from the network, e.g., sent via Radio Resource Control (RRC) signaling, to provide sensing capability information. The initial request may be received after the completion of a random-access procedure, which establishes an initial connection between the WTRU and the network. Upon reception of the initial request, the WTRU constructs a capability information message that outlines support for various sensing functionalities, including advanced features such as the ability to detect and measure MD harmonics or the ability to measure the sensing target periodicity function, etc.

The capability information message may include a wide range of parameters that describe the WTRU's sensing-related characteristics. The parameters may encompass processing capabilities (e.g., support for inverse frequency transforms and the maximum number of samples that can be processed, or the like) alongside supported sensing frequency ranges, total sensing bandwidth, and supported sensing operation modes, including monostatic, bistatic, or hybrid configurations. The message may also specify the WTRU's sensing priorities (e.g., tracking versus detection, or the like), achievable spatial and temporal resolution, and support for Angle of Arrival (AoA) estimation along with the corresponding angular resolution.

In addition, the WTRU may report Doppler resolution capabilities for detecting motion dynamics, as well as reflectivity sensitivity, which refers to the minimum detectable reflection power, signal-to-noise ratio (SNR), absolute amplitude, or the like. The message may further include information about support for carrier phase measurements and the associated phase resolution. The sensing mode, e.g., monostatic sensing, bistatic, etc., along with relevant parameters such as supported frequency ranges and the maximum allowed transmit power for sensing tasks, may also be conveyed.

The capability information is transmitted by the WTRU through RRC signaling, for instance via the Physical Uplink Shared Channel (PUSCH). The network uses this information to make informed decisions regarding the configuration, scheduling, and allocation of sensing-related resources.

For example, regarding the RS configuration, the WTRU can be configured by the network to utilize one or more RSs for sensing purposes in the downlink, uplink, or both directions. In some embodiments, the RS configuration is conveyed through higher layer signaling and encompasses a variety of parameters that define how the RS should be transmitted, received, and interpreted for a given sensing task.

One or more configuration parameters for the RS configuration may include details such as at least one of: the RS identity or index, the total number of RS resources, definitions of resource sets and their corresponding IDs, sequence identifiers used for signal generation, or the like. Temporal characteristics may also be defined, which may include at least one of periodicity, transmission start and end times, applicable time windows for RS activity, or the like. Additional signal structures are provided, which may include at least one of RS type, repetition factor, comb pattern and size, subcarrier spacing, or the like. The additional signal structures help determine waveform properties and spectral granularity of the signal.

From a spatial perspective, the configuration may include at least one of: transmission and reception spatial relations, quasi-colocation (QCL) information, e.g., indicating shared beam or antenna characteristics with other signals, a number of spatial layers used, or the like. Power control aspects may also be defined, such as transmit power levels, power allocation strategies for sensing signals, or the like. Beam-related configurations may include parameters governing beam direction, switching behavior, beam refinement techniques, or the like.

Downlink reference signals configured for sensing may include at least one of Channel State Information RS (CSI-RS), Phase Tracking RS (PTRS), Positioning RS (PRS), Tracking RS (TRS), Synchronization Signal Blocks (SSB), dedicated sensing reference signals tailored for specific use cases, or the like. On the uplink, for example, the network may configure the WTRU with at least one of Sounding RS (SRS), periodic SRS (SRSp), customized uplink sensing RS, or the like.

For example, regarding the one or more RS transmission rate mismatch detection triggering conditions, the WTRU may receive, e.g., as part of a first configuration from a network (e.g., LMF, gNB, or the like), one or more triggers for initiating a procedure to measure one or more RSs reflected from a target, and/or detect an RS transmission rate mismatch. The WTRU can monitor for one or a combination of target profiles. The WTRU is triggered to sense reflections for one or combined targets in time-based, event-based, location-based, mobility-based, and quality of service (QoS)-based triggers, or other predefined criteria.

The WTRU, upon the detection of one or more triggers, may send a request to the network (e.g., LMF, gNB, or the like) for initiating the RS transmission rate mismatch detection using profile measurement (e.g., RS profile, RCS profile, etc.). For example, the initiating can be achieved via an explicit initiation or an implicit initiation. The explicit initiation may be via uplink signaling, e.g., RRC signaling, MAC-CE, uplink control information (UCI), reference signal transmissions, e.g., sounding reference signal (SRS), or the like. The implicit initiation may be through selection of certain uplink resources, for example, resources related to physical random-access channel (PRACH), physical uplink control channel (PUCCH), PUSCH, spatial relation information, etc.

The WTRU may accordingly receive a first configuration from the network to initiate measuring the RS reflected from the target within the configured measurement time window using profile measurements (e.g., RS profile, radar cross section (RCS) profile, etc.) and/or reporting based on the details provided in the initial configuration.

The WTRU may request another target profile and/or one or more scatterer profile sets (e.g., measured at different angle, frequency band, etc.), e.g., from the network, if sensing target and/or scatterer measurements are not satisfactory, e.g., below a certain sensing resolution, unmatched patterns, or the like.

The WTRU may receive another configuration, e.g., from the network, to assist the WTRU with the sensing target reflection measurements. The another configuration (over the first configuration) may include different measurement time window configurations, additional, or more granular information for the WTRU to assist with the required sensing task.

For example, regarding the measurement configurations for the RS profile, the WTRU may receive a configuration from the network that may include an indication from the network to start a sensing task that is related to a sensing target (e.g., target localization, tracking, etc.). The WTRU may receive the configuration via RRC signaling, MAC-CE, DCI, or the like.

The configuration may include a sensing measurement task within a measurement time window and corresponding triggers that may include at least one of: (1) an indication such as a flag to activate or deactivate the sensing measurements; (2) a time window for the target sensing task measurement procedure, e.g., a start time, minimum and/or maximum duration, a number of measurement occasions for update and termination, or the like; (3) one or more measurement configurations for an RS profile (e.g., a measurement time window, RS peak detection criteria, RS metrics to be measured like RSRP, RSRPP, RSCP, SINR, RS selection criteria, etc.); (4) one or more types of RS metric profiles to be measured for the target sensing task measurement, which may include at least one of: (a) RS metric-frequency profile information (e.g., relative received amplitude and optionally phase at different frequencies and/or physical resource block (PRB)), (b) RS metric-angular profile (e.g.: relative received power at a set of relative AoA and/or angle-of-departure (AoD)), or (c) RS metric-time profile information (e.g., relative received amplitude and optionally phase at different time slots and/or PRB), or the like; (5) RS transmission rate mismatch determining triggers, which may include at least one of: (a) time profile based triggers (e.g., number of one or more RSs over threshold time period with constant power or constant rate of change in the power, etc.), (b) frequency profile based triggers (e.g., number of harmonics, range of frequencies, or the like), or (c) spatial profile based triggers, or the like; (6) report update and/or termination triggering conditions, which can define when the WTRU should send a new report or terminate the given sensing task, in which the conditions include at least one of: (a) changes in the measured RS metrics (e.g., sharp drop or rise in RSRP and/or SINR, or the like) where the threshold values of these parameters for activation of the triggering event can be included in the configuration, (b) reaching a threshold confidence level in tracking a target, (c) expiry of the measurement time window without detecting any valid triggers, or (d) receiving an explicit termination instruction from the network via signaling, etc.; or (7) the like.

For example, regarding the report configurations, the network, e.g., BS, gNB, or the like, can configure the WTRU with a reporting configuration. The reporting configuration may include at least one of: (1) Allocated resources for report, wherein the network may allocate specific resources to the WTRU dedicated for measurement reporting in a CSI resource block. These resources may include time-frequency resources (such as specific slots or sub-carriers), uplink control or shared channels and scheduling grants to indicate the WTRU to send the reports on configured resources. (2) The configuration may define the periodicity of reporting information which may include the reports to be send can be wither periodic, or semi-persistent or aperiodic. (3) The configuration may define the triggering conditions of reporting information. (4) The configuration may define the measurement quantities reporting information, (5) Report content that may include at least one of: (a) report on the RS measurements over the measurement time window, (b) report on selected RS measurements over the measurement time window, (c) report on RS profile (e.g., time, frequency, etc.) that may include at least one of: (i) RS measured profile (e.g., time, frequency, etc.), (ii) detected RS transmission rate mismatch (e.g., high or low rate or any other configured type of levels), (iii) comparison measurements between the configured RS profile and the measured RS profile (e.g., correlation measurements, difference measurements, etc.), (d) recommended RS configuration, or the like. (6) Conditions for updating the sensing measurements reports e.g., change in the periodicity or change in the sensing target location, rate of change in periodicity with respect to a pre-configured resource classifying a defined threshold, change in any CIR conditions (e.g., SNR for target reflected path below a certain value, or the like), etc. (7) in some conditions, the WTRU may receive a reconfiguration message to update the reporting parameters for sensing, e.g., from a control or data channel via RRC configuration, DCI information, MAC CE signaling, etc. This message may contain part or all of the above information, and reception of the message may override part or all of a configuration previously received by the WTRU. Or (8) the like.

For example, regarding the sensing assistance data, the network can provide the WTRU with sensing assistance data that includes parameters to aid in performing sensing measurements as part of the configuration. In one example, the WTRU may receive the assistance data associated with the sensing target from the network. In one example, the WTRU may receive the sensing assistance data semi-statically (e.g., via LTE positioning protocol (LPP), RRC messages, or the like). The assistance data may comprise at least one of: (1) Sensing target identifier, in one example, the identifier may be associated to the target type (e.g., human target, vehicles, rocks, or the like) and/or location. In one implementation, the IDs are selected from different pools. In another implementation the type is associated with the target and all targets have IDs from the same pool. (2) Association to the sensing measurement event ID. In one example, the sensing target ID may be the same or part of the sensing measurement event ID. In one example, the sensing measurement event ID may be part of the target ID. In another example, a single target ID may be associated to one or more sensing measurement event IDs. In another example, one or more target IDs may be associated to one or more sensing measurement event IDs. (3) Sensing target profile information, which may include one or more of the following: (a) RS metric-frequency profile information: e.g., relative received amplitude (e.g., RSRP, RSRPP, SINR, etc.) and optionally phase (e.g., RSCP) at different frequencies and/or PRB, (b) RS metric-angular profile: e.g.: relative received power at a set of relative AoA and/or AoD, (c) RS metric-time profile information: e.g., relative received amplitude and optionally phase at different time slots and/or PRB, (d) RCS-frequency profile information: e.g., relative target RCS amplitude and optionally phase at different frequencies and/or PRB, (e) RCS-angular profile: e.g.: relative target RCS at a set of relative AoA and/or AoD, (f) RCS-time profile information: e.g., relative target RCS amplitude and optionally phase at different time slots and/or PRB, or (g) MD profile: e.g., relative target MD amplitude and optionally phase of the target configured MD frequency and/or range of frequencies (e.g., discrete or continuous range) that corresponds to the target relative micro-motion (e.g., vibration, rotation, etc.). (4) Sensing target positioning information, which may include at least one of: (a) absolute (e.g., target coordinates (x, y, z), or the like), (b) relative (e.g., with respect to the coordinates and/or the orientation of the TRP and/or the WTRU, or the like), for example, the WTRU may receive the TRP and/or WTRU positioning and/or orientation information to assist the WTRU to calculate the target location in relative to the WTRU and/or TRP locations, or (c) coarse location (e.g., location is given as area defined between certain coordinates, cell ID, sector ID, etc.). (5) Sensing target mobility information, which may include at least one of: (a) absolute (e.g., target velocity, Doppler frequency, etc.), (b) relative (e.g., with respect to the WTRU and/or TRP velocity, or the like), or (c) uncertainty range (e.g., velocity and/or Doppler frequency, or the like). (6) sensing target MD profile information, which may include at least one of: (a) MD frequency locations (e.g., minimum and/or maximum MD frequency, MD frequency range, number of harmonics, etc.), or (b) MD frequency profile (e.g., expressed in terms of the RS metric frequency profile, statistical model for the MD magnitude at different frequencies, etc.). (7) Validity time for sensing assistance information: The validity time may refer to the total time duration when the sensing assistance data that is provided by the network can be associated to the target. In one example, the validity time may be configured in terms of number of symbols, slots, frames, subframes, seconds, or the like. Or (8) the like.

In certain representative embodiments, the WTRU measurement of the RS profile may include at least one of: measurement of a reflected RS from a target, measurement of an RS metric profile of one or more resolvable paths, measurement of a reflected RS time-profile of a target, measurement of a difference between two profiles, RS transmission rate mismatch determination, frequency-based and/or MD profile-based measurement, time-based measurement, RS transmission rate level determination, or the like.

For example, regarding the measurements of the reflected RS from the target, the WTRU, e.g., after receiving the RS configurations, the target sensing task time window configurations and the sensing assistance data, may receive the RS resources and an indication from the network to initiate the target sensing task.

The WTRU may be configured to perform measurements using the received sequence of one or more sensing RSs, e.g., CSI-RS, PRS, SSB, or the like, within a measurement time window. In one example, the WTRU may receive a set of one or more RSs, e.g., from one or more TRPs, over the configured time, frequency, space and power resource allocations, e.g., frames, sub-frames, slots, PRBs, single or multiple antenna ports, or the like.

In one example, the WTRU may receive a set of one or more RSs and perform a set of sensing measurements in the configured time window.

In one example, the WTRU may use the received one or more RSs during the configured time window to perform at least one of the following measurements: angle measurements, e.g., AoA; temporal measurements, e.g., time of arrival (ToA), time difference of arrival (TDoA), etc.; power measurements, e.g., absolute or relative RSRP, RSRPP, SNR, etc.; mobility measurements, e.g., Doppler; uncertainty in Doppler measurements (e.g., MD motion may be regarded as noise to the Doppler motion, or the like); RCS profile; or the like.

Additionally, the WTRU may use the one or more received RSs to perform at least one of the following measurements: channel responses, e.g., channel impulse response (CIR), power delay profile (PDP), channel frequency response (CFR), etc.; the number of CIR multipath components, e.g., received within the configured window; the peaks of the obtained power response, e.g., peaks of CIR or PDP detect within the configured window; the average of the obtained power responses, e.g., average power of received signals within the configured window; or the like.

In one solution, the WTRU may associate the set of measurements obtained over the configured measurement time window for each target and/or scatterer. For example, the association of the set of measurements obtained over the configured measurement time window for each target and/or scatterer includes at least one of: (1) The WTRU obtains the set of accumulated received power measurements, e.g., the accumulated received SNR per received multipath component for a specific target and/or scatterer, e.g., out of Nₚ total paths, expressed as Equation (2), as follows:

$${SNR}_{t} = {\sum }_{i = 1}^{{N}_{p}} {SNR}_{i} \qquad ( 2 )$$

(2) The WTRU obtains the peak SNR for a specific target over the configured time window, e.g., expressed as Equation (3), as follows:

$${SNR}_{max} = {max ( {SNR}_{i} )}_{i = 1}^{{N}_{p}} \qquad ( 3 )$$

(3) The WTRU obtains average SNR for a specific target over the configured time window, e.g., S̅N̅R̅=SNRₜ/T_{W} where T_{W} is the configured measurement time window length.

(4) The WTRU obtains the set of accumulated received power measurements, e.g., the accumulated power per received multipath component for a specific target and/or scatterer can expressed as Equation (4), as follows:

$${p}_{t} = {\sum }_{i = 1}^{{N}_{p}} {p}_{i} \qquad ( 4 )$$

(5) The WTRU obtains the peak power for a specific target over the configured time window,

$$e . g . , {P}_{max} = {max ( {p}_{i} )}_{i = 1}^{{N}_{p}} .$$

(6) The WTRU obtains average power for a specific target over the configured time window, e.g., p̅ₜ=pₜ/T_{W}.
(7) The angular power characteristics of each received for a specific target and/or scatterer, e.g., power angular profile per target.
(8) The delay power characteristics for a specific target and/or scatterer, e.g., set of PDPs for a specific target.
Or (9) the like.

In one solution, the WTRU may obtain the set of accuracies for each for the sensing measurements, e.g., accuracy of range estimation, accuracy of velocity estimation, RMSE of range estimation, RMSE of velocity estimation, etc. The WTRU may also determine the set of certainty measurements of the obtained angular, temporal, and power measurements, e.g., certainty of AoA, ToA, TDoA, RCS profile, etc.

For example, regarding the measurement of an RS metric profile of the one or more resolvable paths, the WTRU starts measuring the RS metric (e.g., RSRP, RSRPP, RSCP, SINR, etc.) profile of the corresponding received RS resource for each resolvable path within a configured spatial and/or temporal measurement window. In one example, the WTRU may associate the RS metric profile of each resolved path to the corresponding measured AoA and/or ToA.

In one example, the WTRU may measure the RS-metric frequency profile through measurement of the RS metric value (e.g., magnitude, power, phase, or the like) at different frequencies (e.g., frequency PRBs, bandwidth parts (BWP) s, bands, etc.). In one example, the WTRU may measure the RS metric angular profile through the measurement of the RS metric value (e.g., magnitude, power, phase, etc.) at different angles that are associated with the RS resource (e.g., AoA, AoD, etc.). In one example, the WTRU may measure the RS metric time profile, through measurement of the RS metric value (e.g., magnitude, power, phase, etc.) at different time slots (e.g., time PRBs, symbols, frames, subframes, etc.). In one example, the WTRU may measure the RS metric hybrid profile, which can be a combination of RS metric profile over time, frequency, or space.

In one example, the WTRU may measure the RCS profile of a target and/or the scatterer that corresponds to the received RS resources resolvable paths. The WTRU may measure the RCS frequency profile through measurement of the RCS value (e.g., magnitude, phase, or the like) at different frequencies (e.g., frequency PRBs, BWPs, bands, etc.). In one example, the WTRU may measure the RCS angular profile through the measurement of the RCS value (e.g., magnitude, phase, etc.) at resolvable paths of the same RS resource (e.g., AoA, AoD, etc.). In one example, the WTRU may measure the RCS time profile, through measurement of the RCS value (e.g., magnitude, phase, etc.) at different time slots (e.g., time PRBs, symbols, frames, subframes, etc.).

For example, regarding the measurement of the reflected RS time-profile of the target, the WTRU may receive multiple RSs (e.g., from different TRPs and/or single TRP, or the like) associated with the same target. In that case, the WTRU may measure multiple (pre) configured measurements associated with different excess delay with respect to the time of first arrival of the resource associated with the target. In case of association of multiple RS resources with the target, the WTRU may consider the measurement of RS resource considering at least one of the following: RS resource with the highest RSRP and/or RSRPP measurement, average RSRP and/or RSRPP and/or RSCP measurement from the RS resources, RS resource corresponding to the time of first arrival resource, or the like.

In one example, in case the WTRU is configured with multiple measurement occasions, the WTRU may measure the RS-metric (e.g., RSRP, RSRPP, RSCP, etc.) associated with the measurement time for multiple measurement occasions. The WTRU may measure the time relative to the measured time corresponding to the first measurement instance. The WTRU may create an RS-metric (e.g., RSRP, RSRPP, RSCP, etc.) and excess time delay with respect to the first arrival RS profile, from herein referred to as the RS metric-time profile.

In one example, the WTRU may determine the ΔRS metric (e.g., ΔRSRP, ΔRSRPP, ΔRSCP, etc.) from the RS metric-time measurement profile. The WTRU may determine this ΔRS metric as the difference between the RS metric and the (pre) configured static threshold (e.g., associated with the RS metric) for each time instance in the RS metric-time profile within the (pre) configured measurement window. This difference, as used herein, may be referred to as the ΔRS metric-time profile. In one example, the WTRU may select a subset of the one or more measured RSs to be included in the target RS profile based on configured selection criteria (e.g., RSRPP above configured threshold, SINR is above preconfigured threshold, etc.).

The WTRU determines to convert the ΔRS metric-time profile into the amplitude-frequency profile. This amplitude-frequency profile, as used herein, may be referred to as the ΔRS metric-frequency profile. In one example, the WTRU may do the conversion by a (pre) configured method (e.g., Fast-Fourier transform). The WTRU may determine to perform the operation based on at least one of the following conditions: the measured ΔRS metric (e.g., average, maximum, minimum, etc., with respect to different time instances, or the like) in the RS metric-time profile is above a (pre) configured threshold; the difference between two time instances in the ΔRS metric-time profile is below a (pre) configured threshold; or the total number of ΔRS metric-time samples in the profile is above a (pre) configured threshold, etc.

In one example, the WTRU may be configured to perform the frequency transformation based on capability of the WTRU. In one example, the WTRU may determine the ΔRS metric-frequency profile associated with the measurement (e.g., through FFT) based on the provided assistance data. In another example, based on capability of the WTRU to oversample the measurements, the WTRU may also compute the oversampled frequency transformation increasing the granularity of the ΔRS metric-frequency profile.

For example, regarding the measurement of the difference between two profiles, the WTRU may be configured to measure the difference between the measured RS-metric resolvable path profile (e.g., RSRPP, RSCP, SINR, etc.) and a configured profile (e.g., target or scatterer RCS profile, combined target-scatterer RCS profile, etc.). In one solution the WTRU may measure the difference between two profiles as Equation (5), as follows:

$$D = {\sum }_{i = 1}^{M} ( {x}_{i} - {y}_{i} ) \qquad ( 5 )$$

where xᵢ represents the measured value of the RS metric at the i-th point (e.g., frequency, time, angle, etc.), yᵢ represents the configured profile value at the i-th point. D represents the sum of the difference between the measured and configured values of the target and/or scatterer and/or combined (target-scatterer) profile.

In another example, the WTRU may measure the difference between the normalized measured RS metric profile and the normalized configured target and/or scatterer and/or combined (target-scatterer) profile as Equation (6), as follows:

$${D}_{N} = {\sum }_{i = 1}^{M} ( {x}_{N , i} - {y}_{N , i} ) \qquad ( 6 )$$

In another example, the WTRU may measure the correlation between the measured RS metric profile and the configured target and/or scatterer and/or combined (target-scatterer) profile as Equation (7), as follows:

$$C = \frac{{\sum }_{i = 1}^{M} ( {x}_{i} - \overline{x} ) ( {y}_{i} - \overline{y} )}{\sqrt{{\sum }_{i = 1}^{M} {( {x}_{i} - \overline{x} )}^{2} {( {y}_{i} - \overline{y} )}^{2}}} \qquad ( 7 )$$

where, x̅ is the average value of the measured RS metric profile over an M sampling points (e.g. time, frequency, angle, etc.), y̅ is the average value of the configured target and/or scatterer and/or combined (target-scatterer) profile. C represents the correlation coefficient between the two profiles. In another example, the WTRU may measure the correlation between the normalized RS metric profile and the normalized configured target and/or scatterer and/or combined (target-scatterer) profile.

For example, the RS transmission rate mismatch determination may be at least one of: frequency-based, MD profile-based, time-based, or the like.

For example, regarding the frequency-based and/or MD profile-based RS transmission rate mismatch determination, in one solution the WTRU may determine the RS transmission rate mismatch based on the target RS frequency profile and/or MD profile.

In one example, the WTRU may be configured to measure the MD profile of the sensing target using the measured RS metric time and/or frequency profile that is reflected from the target within a measurement time window. The MD profile of the target may be discrete frequencies (e.g., composed of the fundamental MD frequency of the target and harmonics of the fundamental MD frequency, or the like) or continuous range of frequencies based on the type of the target MD motion (e.g., periodic, non-periodic, or the like).

In one example, the WTRU may determine the RS transmission rate mismatch based on the difference between the measured and configured target MD profile is above a configured threshold.

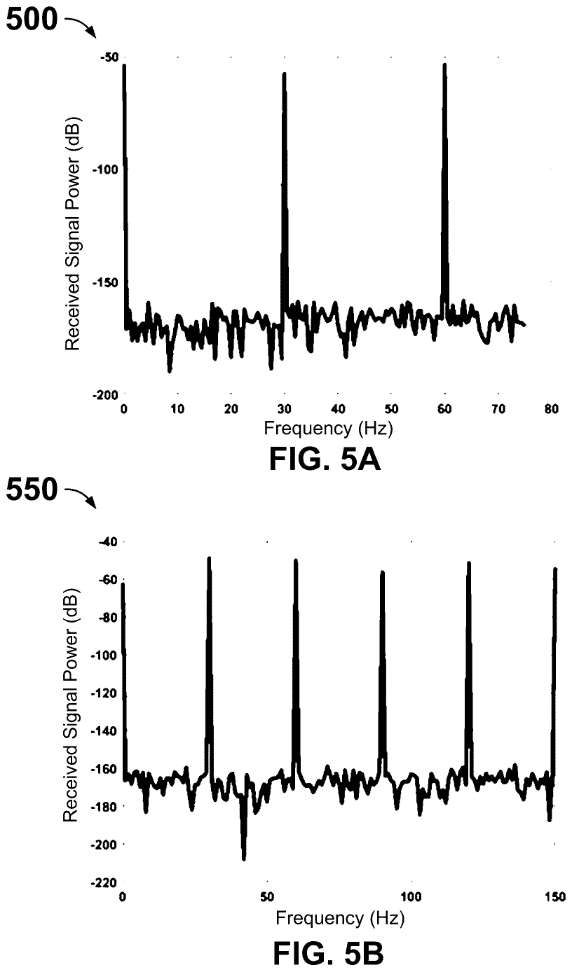

In one example, the WTRU may be configured to measure the number of discrete frequency harmonics in the target MD profile. In another example, the WTRU may measure the range of MD frequencies. In one example, the WTRU may determine the RS transmission rate mismatch based on the difference between the measured and configured number of discrete frequency harmonics in the target MD profile is above a preconfigured threshold. In another example, the WTRU may determine the RS transmission rate mismatch based on the difference between the measured and configured range of target MD frequencies is above a preconfigured threshold. For example, FIGS. 5A and 5B show, in charts 500 and 550, respectively, the difference between the measured and configured target MD profile in terms of the number of the measured harmonics for the target MD motion. The charts 500 and 500 indicate received signal power (dB) (y-axis) versus frequency (Hz) (x-axis).

In one example, the WTRU may be configured with the maximum target MD frequency. The WTRU may determine the transmission rate mismatch based on the difference between the measured and configured maximum target MD frequency. The WTRU may determine the transmission rate mismatch based on the difference between the total number of one or more RSs received within the measurement time window and the estimated number of one or more RSs that should be received by the WTRU to measure the configured maximum target MD frequency. The WTRU may estimate the required number of one or more consequent RSs within a measurement time window based on the following Equation (8):

N=T_{win}/(2f_{MD}) (8)

where T_{win} is the measurement window time, and f_{MD} is the maximum target MD frequency.

In one example, the WTRU may be configured with the maximum energy and/or the energy distribution of the target MD profile in a configured frequency range (e.g., the maximum energy of the target MD profile between frequency f1 and f2 is x, or the like). The WTRU may be configured with the target MD profile energy range in a configured frequency range. The WTRU may determine the RS transmission rate mismatch based on the difference between the measured and configured MD profile energy within a configured frequency range is above a configured threshold.

For example, regarding the time-based RS transmission rate mismatch determination, the WTRU may determine the RS transmission rate mismatch based on the target RS time profile.

In one example, the WTRU may determine the RS transmission rate mismatch based on the difference between the measured and configured target time profile is above a configured threshold.

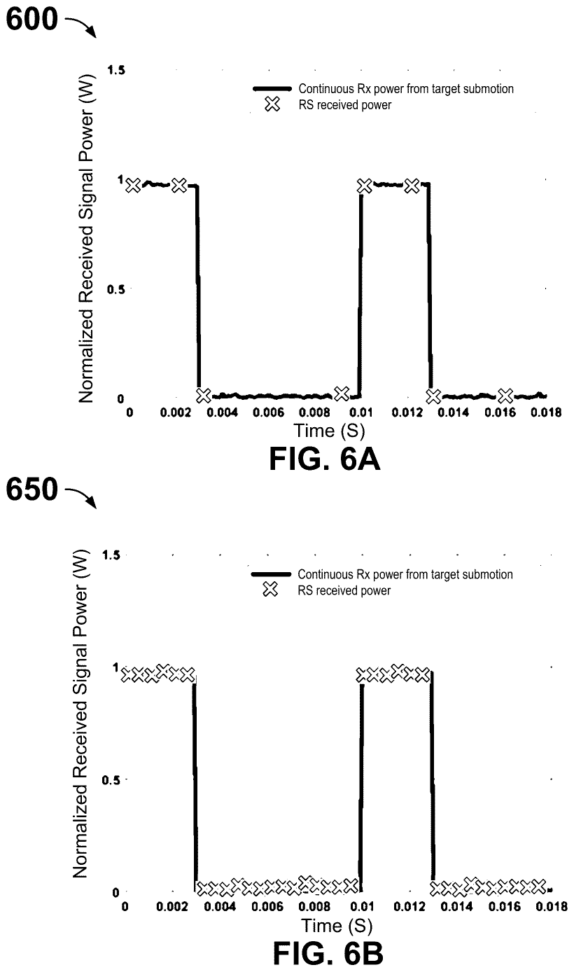

In one example, the WTRU may determine the transmission rate mismatch if the difference between the measured RS metric (e.g., RSRPP, SINR, RSCP, etc.) of two consecutive or configured consecutive N RS(s) within a configured measurement time window is below a configured threshold. For example, FIGS. 6A and 6B show, in charts 600 and 650, respectively, a difference between the configured and measured RSRP time profiles of a target with a lower number of RS received power measurements per unit of time in FIG. 6A, and a higher number of RS received power measurements per unit of time in FIG. 6B. The charts 600 and 650 indicate normalized received signal power (W) (y-axis) versus time(S) (x-axis).

For example, the MD motion of the target may result in an RSRP time profile in the form of a square wave (e.g., as in the case of human motion like standing up, sitting down, or the like). In this case, the WTRU may determine an RS transmission rate mismatch if the difference between the measured RSRP of one or more consecutive RSs is below a configured threshold, e.g., see, FIG. 6B. In one solution, the WTRU may determine the detection of a high RS transmission rate and may recommend an RS configuration (e.g., different RS periodicity, RS power, etc.) to achieve a configured RSRP-time profile, e.g., see, FIG. 6A.

In another example, the WTRU may determine the transmission rate mismatch if the rate of change in the RS metric (e.g., RSRPP, SINR, RSCP, etc.) that is measured for a configured consecutive N RS(s) within a configured measurement time window is constant.

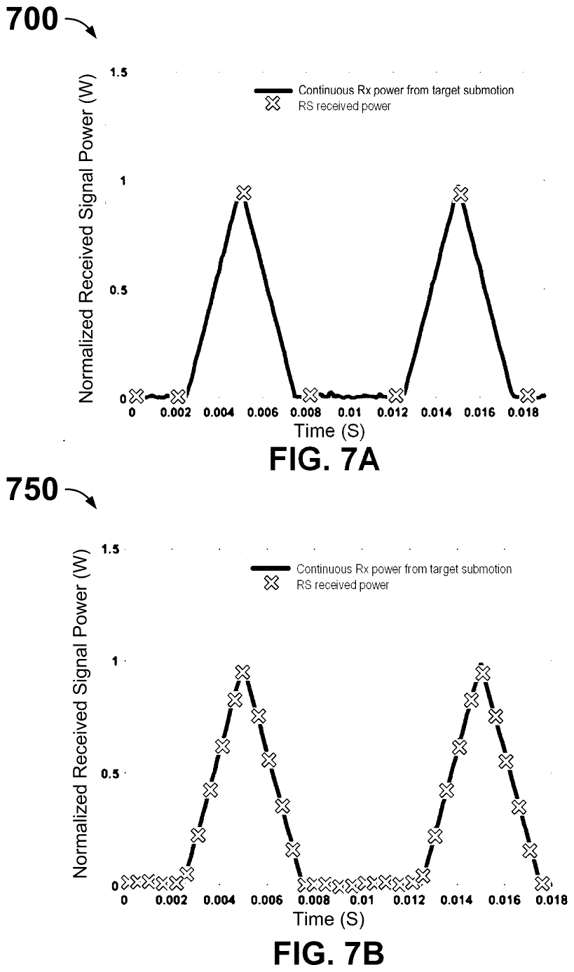

For example, the MD motion of the target may result in an RSRP time profile in the form of sawtooth wave (e.g., as in the case of human swinging arm, walking motion, or the like). In this case, the WTRU may determine an RS transmission rate mismatch if the rate of change in the measured RSRP of one or more consecutive RSs is constant as in FIG. 7B. In one solution, the WTRU may determine the detection of a high RS transmission rate and may recommend an RS configuration (e.g., different RS periodicity, RS power, etc.) to achieve a configured RSRP time profile as in FIG. 7A. For example, FIGS. 7A and 7B show, in charts 700 and 750, respectively, configured and measured RSRP time profiles of a target in FIG. 7A and FIG. 7B, respectively. The charts 700 and 750 indicate normalized received signal power (W) (y-axis) versus time(S) (x-axis).

In another example, the WTRU may determine the degree of interpolation polynomial that describes the measured RS metric (e.g., RSRPP, RSCP, SINR, etc.) of a configured consecutive N RS(s) within a configured measurement time window. For example, the two sawtooth MD motion waveforms illustrated in FIGS. 7A and 7B may be interpolated using polynomials of the first degree (single line). For a curve that passes through k points, the minimum degree of interpolation polynomial that passes through these k points is (k-1). In one solution, the WTRU may be configured with interpolation polynomial for the target MD motion of degree K-1. The WTRU may determine the transmission rate mismatch based on the difference between the configured consecutive N RS(s) within the measurement time window and the determined degree of the interpolation polynomial is above a configured threshold.

In one example, the WTRU may be configured with the maximum energy and/or the energy distribution of the target time profile in a configured measurement time window range (e.g., the maximum energy of the target time profile between time t1 and t2 is x, or the like). The WTRU may be configured with the target time profile energy range in a configured measurement time range. The WTRU may determine the RS transmission rate mismatch based on the difference between the measured and configured time profile energy within a configured measurement time range is above a configured threshold.

For example, regarding the RS transmission rate level determination, the WTRU may be configured to determine the RS transmission rate level within a configured measurement time window, wherein the RS transmission rate level may be determined as a hard level (e.g., high or low) or soft levels (e.g., in the form of numbers 0-10, where level 5 for example may indicate an optimum RS transmission rate, below 5 may indicate a low transmission rate, and above 5 may indicate a high transmission rate, or the like).

In one example, the WTRU may determine the RS transmission rate mismatch for a subset of the one or more RSs that are transmitted within part of the measurement time window. In another example, the WTRU may determine different RS transmission rate levels for different subsets of the one or more RSs that are transmitted within a measurement time window (e.g., the WTRU determine the RS transmission rate x for time period t1-t2, determine the RS transmission rate y for time period t2-t3, and the measurement time window is from t1-t3, or the like).

In one example, the WTRU may determine that the RS transmission rate level (e.g., high or low) for a configured consecutive N RS(s) within a configured measurement time window based on at least one of the following thresholds: (1) the measured number of target MD harmonics is above or below the configured number of harmonics, (2) the measured maximum target MD frequency is above or below a configured threshold, (3) the measured range of frequencies in target MD and/or RS metric frequency profile is above or below a configured threshold, (4) the measured energy of the target MD profile within a configured frequency range is above or below a configured threshold, (5) the number of the one or more measured RSs that are reflected from the target within the measurement time window (or time period of the measurement time window) is above or below the preconfigured threshold (e.g., as in the interpolation polynomial degree), (6) the difference in the measured RS metric of configured consecutive N RS(s) within the measurement time window or configured time period of the measurement time window is below a preconfigured threshold, (7) the difference in rate of change in the measured RS metric of configured consecutive N RS(s) within the measurement time window or configured time period of the measurement time window is below a preconfigured threshold, (8) the measured energy of the configured consecutive N RS(s) that are reflected from the target within a configured measurement time window is above or below a configured threshold, (9) target sensing link status (e.g., LOS and/or NLoS), (10) number of EOs is above or below a preconfigured threshold, (11) the minimum distance between the EO and the target is above or below a preconfigured threshold, or (12) the like.

For example, regarding the WTRU reporting, the WTRU performs RS transmission rate measurements (e.g., RS measurements, RS profile measurements, etc.) and reports and/or sends and/or recommends to NW (e.g., gNB and/or LMF and/or sensing entity, or the like) in periodic, aperiodic or semi-persistent form over an uplink control or data channel.

In one example, the WTRU may determine the report mode based on at least one of the following: reporting configuration, triggered event, RS measurements, RS profile measurements, NW entity that initiated the procedure, other defined parameters, or the like.

In one example, the WTRU may select a subset of the one or more measured reflected RSs from the target to report based on the determination of the RS transmission rate mismatch. For example, if the RS transmission rate is above a configured rate with a specific threshold, the WTRU may select a subset of the one or more measured reflected RSs within the measurement time window to report corresponding measurements of the WTRU. The number of the one or more selected RSs may be determined based on the configured RS transmission rate within the measurement time window. The WTRU may select the one or more RSs to report within a configured measurement time window based on at least one of the following: (1) the difference between the measured number of target MD harmonics and the configured number of harmonics is below a configured threshold; (2) the difference between the measured and configured maximum target MD frequency is below a configured threshold; (3) the difference between the measured and configured range of frequencies in target MD and/or RS metric frequency profile is below a configured threshold; (4) the difference between the measured and configured energy of the target MD profile within a configured frequency range is below a configured threshold; (5) the difference between the measured and configured number of one or more RSs that are reflected from the target within the measurement time window (or time period of the measurement time window) is below the preconfigured threshold (e.g., as in the interpolation polynomial degree); (6) the difference in the measured RS metric of configured consecutive N RS(s) within the measurement time window or configured time period of the measurement time window is above a preconfigured threshold; (7) the difference in rate of change in the measured RS metric of configured consecutive N RS(s) within the measurement time window or configured time period of the measurement time window is above a preconfigured threshold; (8) the difference between the measured and configured energy of the configured consecutive N RS(s) that are reflected from the target within a configured measurement time window is below a configured threshold; or (9) the like.

In one example, the WTRU may report and/or indicate and/or include in the RS measurement report information that may include at least one of the following: (1) RS measurements, which may be associated with target object with uncertainties, which may include at least one of: (a) RS metric and/or profile measurements, (b) RS metric and/or profile comparison measurements, (c) RS selection criteria (e.g., number of selected one or more RSs in the profile, percentage, etc.), or (d) the like; (2) measurement method used (e.g., absolute and/or relative); (3) measurement triggers; (4) measurements granularity; (5) measurement reference values; (6) measurement time window (e.g., length of the window, type, method used to calculate, start time of the window, etc.); or (7) the like.

In one example, the WTRU may determine the report type and content based on one or more determined events (e.g., RS transmission rate mismatch, RS transmission rate level, or the like). The WTRU may send the report to the NW that may contain at least one of the following: (1) RS transmission rate mismatch detection; (2) associated time interval of the mismatch within the measurement time window (e.g., expressed in terms of ToA (t1-t2) within the measurement time window, or expressed in terms of the ToA associated with subset of one or more RSs, or the like); (3) RS transmission rate level (e.g., hard level as high or low, soft levels that can be defined as integer levels, or the like), e.g., the WTRU may associate a different RS transmission rate level to each time interval of the measurement time window; (4) RS transmission rate level determining criteria (e.g., time-based, frequency based, etc.); or (5) the like.

In one example, the WTRU may report and/or suggest and/or recommend to the NW as a function of the determined triggering event at least one of the following: (1) recommended RS configuration (e.g., periodicity, power, frequency, etc.) for a current and/or future transmission, e.g., indicated RS to begin within X time-unit from a reference point in time; (2) recommended intervals of one or more measurement time windows, e.g., measurement time window [t0-tn], the WTRU recommends number of intervals and ranges within the measurement time window; (3) recommended RS periodicity on each recommended time window interval (e.g., periodicity x is recommended for time interval t1-t2, periodicity y is recommended for time interval t2-t3, etc.); (4) recommended RS configuration on each recommended time window interval that may include at least one of: (a) RS transmission rate configuration (e.g., periodicity, repetition factor, muting pattern etc.), (b) RS transmission power, (c) RS transmission frequency, (d) an index associated with an RS rate, (e) up or down command to increase or decrease RS rate, or (f) the like; (5) recommended periodicity time function, e.g., distribution of RS versus time; (6) recommended power time function; or (7) the like.

In one example, the WTRU may send an index associated with the RS transmission rate over any configured uplink control or data channel, wherein the index corresponds to one of a plurality of preconfigured RS transmission rate levels. In another example, The WTRU may send and up or down command to indicate a preferred increase or decrease in the RS transmission rate, respectively. In one solution, the WTRU may send the index or the up or down command over a dedicated reporting resources.

In one example, the WTRU may send the RS transmission rate report over any configured uplink control or data channel. In another example, the WTRU may be configured to send each report mode on preconfigured uplink control or data channel based on the report type and/or triggering event type (e.g., report mode 1 sent over PUSCH, while report mode 2 over PUCCH, or the like).

In one solution, the measurement report may be transmitted through PUSCH, e.g., via RRC and/or MAC-CE through a configured scheduling mechanism (e.g., a configured grant).

In one example, the WTRU may be configured to send decoding information (e.g., report format, type of content, allocated fields for each measurement, periodicity time function, power time function, etc.) for the RS transmission rate report on specific uplink control or data channel (e.g., the WTRU may send the decoding information of the report associated with micro-sampling measurements and/or events on the PUCCH, or the like). In another example, the gNB may blind-decode the received RS transmission rate report from the WTRU. In one example, the WTRU may be configured to send a report to the network on a specific uplink control or data channel based on the measurement time granularity.

In another example, the WTRU may be configured to send a report to the network on a specific uplink control or data channel based on the report periodicity type (e.g., periodic, aperiodic, semi-persistent, etc.).

In one example, the WTRU may determine the event of RS transmission rate mismatch procedure and report to the network in a periodic, aperiodic or semi-persistent form. In one example, the WTRU may be configured with specific reporting periodicity that is associated to the determined event (e.g., RS rate is high, RS rate is low, etc.). In another example, the WTRU may be configured with reporting periodicity that is associated to the likelihood of a certain event. In another example, the WTRU may be configured with a specific reporting periodicity that is associated to the reliability of sensing measurements.

For example, regarding the WTRU report update, the report update may also be triggered by a request received by the WTRU from the network to provide this update in accordance with an associated configuration.

The update report may include a subset of the original WTRU report detailed herein or the full report, as indicated in the associated configuration. The report update may also include absolute measurements or relative measurements to the previous report sent, or only meaningful changes in certain measurements as indicated in the associated configuration.

The report update may be either periodic or aperiodic, regular or ad-hoc (e.g., on demand) as indicated in the associated configuration.

In one example, the WTRU may be configured to perform RS transmission rate measurements (e.g., metric and/or profile measurements) on the RS reflected from the target over multiple measurement occasions (e.g., multi-slot level, e.g., repetition factor, time gap configurations, or the like). In this example, based on a corresponding configuration, the WTRU may monitor changes in some measurement metrics with respect to the configured thresholds over a given period of time and subsequent to the reporting of the original report back to the network. Examples of these changes may include at least one of: (1) the change of the one or more of RS metric measurements above or below a preconfigured threshold; (2) the change of the RS profile measurements above or below a preconfigured threshold; (3) the change of the determined RS transmission rate above or below a preconfigured threshold; (4) the change of the determined RS transmission event, e.g., from high to low or vice versa; (5) the change of the recommended periodicity time function above or below a preconfigured threshold; (6) the change of the recommended power time function above or below a preconfigured threshold; (7) the change of WTRU location, e.g., moving outside a preconfigured geographical location, that may be changing in positioning measurements either from serving TRP or neighbor TRPs reflected change of one or more positioning related measurements above or below a predefined threshold; (8) the change of target location, e.g., target location outside a preconfigured sensing area, that may be changing in target sensing measurements reflected change of one or more positioning related measurements above or below a predefined threshold; (9) the change of environment, e.g., captured by change in CIR, PDP, DP, etc.; (10) the change of triggering event conditions; (11) the change in the one or more measured RS metrics and/or one or more KPIs over a preconfigured threshold; (12) receiving an update request by the NW (e.g., gNB, LMF, SF, or the like); or (13) the like.

Based on the above, and the corresponding configuration, the WTRU may compile a report update including the updated RS transmission rate measurements containing at least one of the following: (1) time stamp of the updated measurements, e.g., in absolute or relative time, or number of slots, frames, etc. relative to a known reference; (2) updated antenna ports involved in the measurements; (3) updated reference signal resources employed in the measurements; (4) updated RS metric measurements; (5) updated RS profile measurements; (6) updated RS transmission rate event (e.g., low, high, or the like); (7) updated recommended RS configuration, e.g., updated periodicity time function, updated power time function, etc.; (8) updated validity window; or (9) the like.

In another example, the WTRU may be configured to report an indication to the network when one or more metrics measured and reported in the original report back to the network may have changed, e.g., based on set thresholds and compared to the values in the original report. Such indication may be used by the network to determine whether a partial or full report update may be requested from the WTRU.

For example, the additional WTRU behaviors include at least one of reliability conditions, exit and/or failure and/or termination conditions, or the like.

For example, regarding the reliability conditions, the WTRU may process the RS and/or metric profile measurements to obtain their reliability using the set of direct measurements, e.g., RS measurements, and indirect measurements, e.g., AoA, ToA, RCS, etc. In one example, the WTRU may determine at least one of the following certainties and/or uncertainties of indirect measurements: (1) the certainty and/or uncertainty of measurements, e.g., certainty of AoA, ToA, TDoA, SNR, Doppler, RCS etc. In one example, if the certainty; (2) the certainty and/or uncertainty of channel response measurements, e.g., CIR, CFR, PDP, etc.; (3) the certainty and/or uncertainty of sensing measurements, e.g., RCS, range, velocity, etc.; or (4) the like.

In another example, the WTRU may determine at least one of the following certainties and/or uncertainties of direct RS metric measurements: (1) the certainty and/or uncertainty of frequency-based RS metric measurements; (2) the certainty and/or uncertainty of time-based RS metric measurements; (3) the certainty and/or uncertainty of spatially-based RS metric measurements; (4) the certainty and/or uncertainty of the measured number of harmonics, range of measured frequencies, etc.; (5) the certainty and/or uncertainty of the selected RS resource with the highest RSRP and/or RSRPP measurement; (6) the certainty and/or uncertainty of the measured ΔRS metric (e.g., average, maximum, minimum, etc., with respect to different time instances, or the like); (7) the certainty and/or uncertainty of the excess time delay with respect to the first arrival RS profile; or (8) the like.

In one solution, the WTRU may determine that the RS and/or metric profile measurements are unreliable, e.g., when at least one of the following is determined: (1) the uncertainty of an indirect measurement is above a specified threshold; (2) the certainty and/or uncertainty of an indirect measurement is within and/or outside a threshold; (3) the uncertainty of a direct measurement is above a specified threshold; (4) the certainty and/or uncertainty of a direct measurement is within and/or outside a threshold; or (5) the like. Also, for example, when the WTRU determines that the RS and/or metric profile measurements are unreliable, the WTRU may apply at least one of the following: (1) the WTRU may request an update of the sensing configuration; (2) the WTRU may activate carrier aggregation to improve the sensing performance, e.g., range resolution, etc.; (3) the WTRU may use forward and/or backward scattering measurements; (4) the WTRU may request an update of the sensing configuration; (5) the WTRU may fall back to a default configuration; (6) the WTRU may terminate the reporting of RS metric measurements; or (7) the like.

For example, regarding the exit and/or failure and/or termination conditions, the WTRU is configured to perform the RS metric and/or profile measurements over multiple measurement occasions (e.g., multi-slot level, e.g., repetition factor, time gap configurations). In one example, the WTRU may determine that periodic reporting of the RS transmission rate measurements and information can be terminated based on at least one of the following: (1) the determination of no change in one or more of the RS metric measurements over a predefined period; (2) the determination of no change in one or more of the RS profile measurements over a predefined period; (3) the determination of no change in RS rate event (high or low-rate transmission) over a predefined period; (4) the determination of no change in periodicity time function over a predefined period; (5) the determination of no change in power time function over a predefined period; (6) the determination of no change in one or more of triggered WTRU behaviors over a predefined period; (7) achieving the sensing requirements over a predefined period; (8) a time elapsed since the last reporting of precoding feedback information exceeding a maximum absolute or relative duration; (9) a low-battery indication by the WTRU; (10) a termination indication by the network; or (11) the like.

In a solution, based on any of the above, the WTRU may terminate the procedure of RS transmission rate measurements and may send a report over a UL control or data channel containing the recommendation to terminate the measurement procedure and at least one of the following: (1) Termination indicator. In one example, the termination indicator may refer to the reason of termination. For example, termination indicator=1 refers to determined high-rate RS transmission for N measurement occasions. While an indicator value=2 refers to determined low-rate RS transmission for N measurement occasions. (2) Termination time stamp. (3) Detailed termination reason including one or more of the aforementioned reasons. (4) The latest RS transmission rate measurements report including, requested information, RS metric and/or profile measurements performed, determined transmission rate events, existing triggering conditions, WTRU actions performed, time stamps, RS signal ID used for sensing, etc. Or (5) the like.

In certain representative embodiments, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

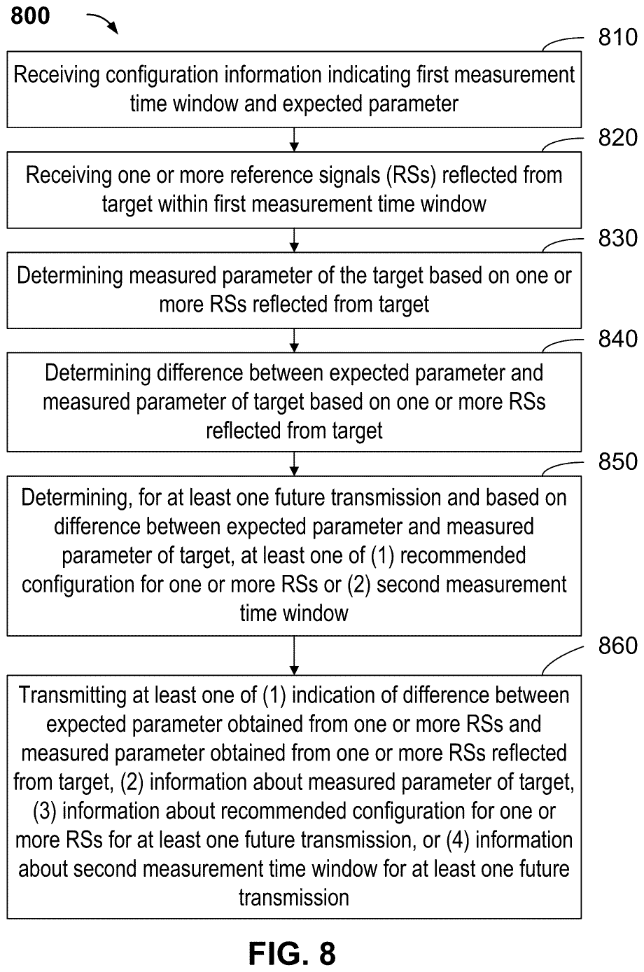

FIG. 8 is a flowchart of an example process 800. In some implementations, one or more process blocks of FIG. 8 may be performed by a device (e.g., WTRU 102, 230, or the like). In certain representative embodiments, as shown in FIG. 8, a process 800 may include receiving 810, from a wireless network (e.g., RAN 104, gNB 180a, 180b, 180c, RAN 113, gNB 210, or the like), configuration information indicating a first measurement time window and an expected parameter. The process 800 may also include receiving 820 one or more reference signals (RSS) (e.g., RS 225) reflected from a target (e.g., UAV 220) within the first measurement time window. The process 800 may furthermore include determining 830 a measured parameter of the target based on the one or more RSs reflected from the target. The process 800 may in addition include determining 840 a difference (e.g., FIGS. 5A and 5B; or FIGS. 6A and 6B; or FIGS. 7A and 7B) between the expected parameter and the measured parameter of the target based on the one or more RSs reflected from the target. The process 800 may moreover include determining 850, for at least one future transmission and based on the difference between the expected parameter and the measured parameter of the target, at least one of (1) a recommended configuration for the one or more RSs or (2) a second measurement time window. The process 800 may also include transmitting 860, to the wireless network, at least one of (1) an indication of the difference between the expected parameter obtained from the one or more RSs and the measured parameter obtained from the one or more RSs reflected from the target, (2) information about the measured parameter of the target, (3) information about the recommended configuration for the one or more RSs for the at least one future transmission, or (4) information about the second measurement time window for the at least one future transmission. Other embodiments of this aspect include corresponding computer systems, apparatus, and computer programs recorded on one or more computer storage devices, each configured to perform the actions of the process 800.

Implementations may include one or more of the following features. The process 800 where: the expected parameter obtained from the one or more RSs reflected from the target is an expected micro-Doppler (MD) profile, and the measured parameter of the target based on the one or more RSs reflected from the target is a measured MD profile. The process 800 where the determining 840 the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target satisfies a configured number of harmonics. The process 800 where the determining 840 the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target reflected from the target within the first measurement time window satisfies a configured threshold. The process 800 where the determining 840 the difference between the expected MD profile obtained from the one or more RSs reflected from the target, and the measured MD profile of the target based on the one or more RSs reflected from the target within the first measurement time window is further based on determining that a difference in a measured metric of the one or more RSs of a configured number of consecutive RSs within the first measurement time window satisfies a configured threshold. The process 800 where the determining 840 the difference between the expected MD profile obtained from the one or more RSs reflected from the target, and the measured MD profile of the target based on the one or more RSs reflected from the target within the first measurement time window is further based on determining a difference in a rate of change in a measured metric of the one or more RSs of a configured number of consecutive RSs within the first measurement time window satisfies a configured threshold. The process 800 where the determining 840 the difference between the expected MD profile obtained from the one or more RSs reflected from the target, and the measured MD profile of the target based on the one or more RSs reflected from the target within the first measurement time window is further based on expected maximum target MD frequency and measured maximum target MD frequency. The process 800 where the determining 840 the difference between the expected MD profile obtained from the one or more RSs reflected from the target, and the measured MD profile of the target based on the one or more RSs reflected from the target within the first measurement time window is further based on expected maximum MD profile energy and measured maximum MD profile energy. The process 800 where the determining 840 the difference between the expected MD profile obtained from the one or more RSs reflected from the target, and the measured MD profile of the target based on the one or more RSs reflected from the target within the first measurement time window is further based on expected time profile energy and measured time profile energy. The process 800 where: the expected parameter obtained from the one or more RSs reflected from the target is at least one of a transmission rate of the one or more RSs configured by the wireless network, an expected MD profile, an expected radar cross section (RCS), an expected power profile, or an expected angle profile, and the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile. Implementations of the described techniques may include hardware, a method or process, or a computer tangible medium.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

In certain representative embodiments, a WTRU (e.g., WTRU 102, 230, or the like) may include a processor (e.g., 118), and a transceiver (e.g., 120) coupled to the processor, where the WTRU is configured to: receive, from a wireless network (e.g., RAN 104, gNB 180a, 180b, 180c, RAN 113, gNB 210, or the like), configuration information indicating a first measurement time window and an expected parameter; receive one or more reference signals (RSs) (e.g., RS 225) reflected from a target (e.g., UAV 220) within the first measurement time window; determine a measured parameter of the target based on the one or more RSs reflected from the target; determine a difference (e.g., FIGS. 5A and 5B; or FIGS. 6A and 6B; or FIGS. 7A and 7B) between the expected parameter and the measured parameter of the target based on the one or more RSs reflected from the target; determine, for at least one future transmission and based on the difference between the expected parameter and the measured parameter of the target, at least one of (1) a recommended configuration for the one or more RSs or (2) a second measurement time window; and transmit, to the wireless network, at least one of (1) an indication of the difference between the expected parameter obtained from the one or more RSs and the measured parameter obtained from the one or more RSs reflected from the target, (2) information about the measured parameter of the target, (3) information about the recommended configuration for the one or more RSs for the at least one future transmission, or (4) information about the second measurement time window for the at least one future transmission. Other embodiments of this aspect include corresponding computer systems, apparatus, and computer programs recorded on one or more computer storage devices, each configured to perform the actions of the methods.

Implementations may include one or more of the following features. The WTRU where: the expected parameter obtained from the one or more RSs reflected from the target is an expected micro-Doppler (MD) profile, and the measured parameter of the target based on the one or more RSs reflected from the target is a measured MD profile. The WTRU where the WTRU configured to determine the difference between the expected MD profile obtained from the one or more RSs reflected from the target, and the measured MD profile of the target based on the one or more RSs reflected from the target within the first measurement time window further determines that a number of measured harmonics of the measured MD profile of the target satisfies a configured number of harmonics. The WTRU may be configured to determine the difference between the expected MD profile obtained from the one or more RSs reflected from the target, and the measured MD profile of the target based on the one or more RSs reflected from the target within the first measurement time window is further configured to determine that a number of measured harmonics of the measured MD profile of the target reflected from the target within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is further configured to determine that a difference in a measured metric of the one or more RSs of a configured number of consecutive RSs within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is further configured to determine a difference in a rate of change in a measured metric of the one or more RSs of a configured number of consecutive RSs within the first measurement time window satisfies a configured threshold. The WTRU may be configured to determine the difference between the expected MD profile obtained from the one or more RSs reflected from the target, and the measured MD profile of the target based on the one or more RSs reflected from the target within the first measurement time window is based on expected maximum target MD frequency and measured maximum target MD frequency. The WTRU may be configured to determine the difference between the expected MD profile obtained from the one or more RSs reflected from the target, and the measured MD profile of the target based on the one or more RSs reflected from the target within the first measurement time window is based on expected maximum MD profile energy and measured maximum MD profile energy. The WTRU may be configured to determine the difference between the expected MD profile obtained from the one or more RSs reflected from the target, and the measured MD profile of the target based on the one or more RSs reflected from the target within the first measurement time window is based on expected time profile energy and measured time profile energy. The expected parameter obtained from the one or more RSs reflected from the target is at least one of a transmission rate of the one or more RSs configured by the wireless network, an expected MD profile, an expected radar cross section (RCS), an expected power profile, or an expected angle profile, and the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile. Implementations of the described techniques may include hardware, a method or process, or a computer tangible medium.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU), (ii) any of a number of embodiments of a WTRU, (iii) a wireless-capable and/or wired-capable (e.g., tetherable) device configured with, inter alia, some or all structures and functionality of a WTRU, (iv) a wireless-capable and/or wired-capable device configured with less than all structures and functionality of a WTRU, or (v) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, or methods described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing and/or communication and/or network computing and/or communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or § 112 (f), or means-plus-function claim format, and any claim without the terms “means for” is not so intended.

What is claimed is:

1. A method performed by a wireless transmit and/or receive unit (WTRU), the method comprising:
receiving, from a wireless network, configuration information indicating a first measurement time window and an expected parameter;
receiving one or more reference signals (RSs) reflected from a target within the first measurement time window;
determining a measured parameter of the target based on the one or more RSs reflected from the target;
determining a difference between the expected parameter and the measured parameter of the target based on the one or more RSs reflected from the target;
determining, for at least one future transmission and based on the difference between the expected parameter and the measured parameter of the target, at least one of (1) a recommended configuration for the one or more RSs or (2) a second measurement time window; and
transmitting, to the wireless network, at least one of (1) an indication of the difference between the expected parameter obtained from the one or more RSs and the measured parameter obtained from the one or more RSs reflected from the target, (2) information about the measured parameter of the target, (3) information about the recommended configuration for the one or more RSs for the at least one future transmission, or (4) information about the second measurement time window for the at least one future transmission.

2. The method of claim 1, wherein:
the expected parameter obtained from the one or more RSs reflected from the target is an expected micro-Doppler (MD) profile, and
the measured parameter of the target based on the one or more RSs reflected from the target is a measured MD profile.

3. The method of claim 2, wherein the determining the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target satisfies a configured number of harmonics.

4. The method of claim 2, wherein the determining the difference between the expected MD profile obtained from the one or more RSs reflected from the target, and the measured MD profile of the target based on the one or more RSs reflected from the target within the first measurement time window is further based on determining that a number of measured harmonics of the measured MD profile of the target reflected from the target within the first measurement time window satisfies a configured threshold.

5. The method of claim 2, wherein the determining the difference between the expected MD profile obtained from the one or more RSs reflected from the target, and the measured MD profile of the target based on the one or more RSs reflected from the target within the first measurement time window is further based on determining that a difference in a measured metric of the one or more RSs of a configured number of consecutive RSs within the first measurement time window satisfies a configured threshold.

6. The method of claim 2, wherein the determining the difference between the expected MD profile obtained from the one or more RSs reflected from the target, and the measured MD profile of the target based on the one or more RSs reflected from the target within the first measurement time window is further based on determining a difference in a rate of change in a measured metric of the one or more RSs of a configured number of consecutive RSs within the first measurement time window satisfies a configured threshold.

7. The method of claim 2, wherein the determining the difference between the expected MD profile obtained from the one or more RSs reflected from the target, and the measured MD profile of the target based on the one or more RSs reflected from the target within the first measurement time window is further based on expected maximum target MD frequency and measured maximum target MD frequency.

8. The method of claim 2, wherein the determining the difference between the expected MD profile obtained from the one or more RSs reflected from the target, and the measured MD profile of the target based on the one or more RSs reflected from the target within the first measurement time window is further based on expected maximum MD profile energy and measured maximum MD profile energy.

9. The method of claim 2, wherein the determining the difference between the expected MD profile obtained from the one or more RSs reflected from the target, and the measured MD profile of the target based on the one or more RSs reflected from the target within the first measurement time window is further based on expected time profile energy and measured time profile energy.

10. The method of claim 1, wherein:
the expected parameter obtained from the one or more RSs reflected from the target is at least one of a transmission rate of the one or more RSs configured by the wireless network, an expected MD profile, an expected radar cross section (RCS), an expected power profile, or an expected angle profile, and
the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile.

11. A wireless transmit and/or receive unit (WTRU), comprising:
a processor, and
a transceiver coupled to the processor, wherein the WTRU is configured to:
receive, from a wireless network, configuration information indicating a first measurement time window and an expected parameter;
receive one or more reference signals (RSs) reflected from a target within the first measurement time window;
determine a measured parameter of the target based on the one or more RSs reflected from the target;
determine a difference between the expected parameter and the measured parameter of the target based on the one or more RSs reflected from the target;
determine, for at least one future transmission and based on the difference between the expected parameter and the measured parameter of the target, at least one of (1) a recommended configuration for the one or more RSs or (2) a second measurement time window; and
transmit, to the wireless network, at least one of (1) an indication of the difference between the expected parameter obtained from the one or more RSs and the measured parameter obtained from the one or more RSs reflected from the target, (2) information about the measured parameter of the target, (3) information about the recommended configuration for the one or more RSs for the at least one future transmission, or (4) information about the second measurement time window for the at least one future transmission.

12. The WTRU of claim 11, wherein:
the expected parameter obtained from the one or more RSs reflected from the target is an expected micro-Doppler (MD) profile, and
the measured parameter of the target based on the one or more RSs reflected from the target is a measured MD profile.

13. The WTRU of claim 12, wherein the WTRU configured to determine the difference between the expected MD profile obtained from the one or more RSs reflected from the target, and the measured MD profile of the target based on the one or more RSs reflected from the target within the first measurement time window further determines that a number of measured harmonics of the measured MD profile of the target satisfies a configured number of harmonics.

14. The WTRU of claim 12, wherein the WTRU configured to determine the difference between the expected MD profile obtained from the one or more RSs reflected from the target, and the measured MD profile of the target based on the one or more RSs reflected from the target within the first measurement time window is further configured to determine that a number of measured harmonics of the measured MD profile of the target reflected from the target within the first measurement time window satisfies a configured threshold.

15. The WTRU of claim 12, wherein the WTRU configured to determine the difference between the expected MD profile obtained from the one or more RSs reflected from the target, and the measured MD profile of the target based on the one or more RSs reflected from the target within the first measurement time window is further configured to determine that a difference in a measured metric of the one or more RSs of a configured number of consecutive RSs within the first measurement time window satisfies a configured threshold.

16. The WTRU of claim 12, wherein the WTRU configured to determine the difference between the expected MD profile obtained from the one or more RSs reflected from the target, and the measured MD profile of the target based on the one or more RSs reflected from the target within the first measurement time window is further configured to determine a difference in a rate of change in a measured metric of the one or more RSs of a configured number of consecutive RSs within the first measurement time window satisfies a configured threshold.

17. The WTRU of claim 12, wherein the WTRU configured to determine the difference between the expected MD profile obtained from the one or more RSs reflected from the target, and the measured MD profile of the target based on the one or more RSs reflected from the target within the first measurement time window is based on expected maximum target MD frequency and measured maximum target MD frequency.

18. The WTRU of claim 12, wherein the WTRU configured to determine the difference between the expected MD profile obtained from the one or more RSs reflected from the target, and the measured MD profile of the target based on the one or more RSs reflected from the target within the first measurement time window is based on expected maximum MD profile energy and measured maximum MD profile energy.

19. The WTRU of claim 12, wherein the WTRU configured to determine the difference between the expected MD profile obtained from the one or more RSs reflected from the target, and the measured MD profile of the target based on the one or more RSs reflected from the target within the first measurement time window is based on expected time profile energy and measured time profile energy.

20. The WTRU of claim 11, wherein:
the expected parameter obtained from the one or more RSs reflected from the target is at least one of a transmission rate of the one or more RSs configured by the wireless network, an expected MD profile, an expected radar cross section (RCS), an expected power profile, or an expected angle profile, and
the measured parameter of the target based on the one or more RSs reflected from the target is at least one of a measured transmission rate of the one or more RSs measured by the WTRU, a measured MD profile, a measured radar cross section (RCS), a measured power profile, or a measured angle profile.
